(19) United States
(12) Patent Application Publication
(10) Pub. No.: US 2026/0095090 A1
(43) Pub. Date: Apr. 2, 2026

(54) POWER MANAGEMENT INTEGRATED CIRCUIT INCLUDING NOISE ELIMINATION MODULE, OPERATION METHOD THEREOF AND ELECTRONIC DEVICE INCLUDING THE SAME

(71) Applicant: Samsung Electronics Co., Ltd., Suwon-si (KR)

(72) Inventors: Donghee CHO, Suwon-si (KR); Taesung KIM, Suwon-si (KR); HYEUNGJOON CHA, Suwon-si (KR); DAE-HOON HAN, Suwon-si (KR); HEESEOK HAN, Suwon-si (KR)

(21) Appl. No.: 19/279,190

(22) Filed: Jul. 24, 2025

(30) Foreign Application Priority Data
Sep. 27, 2024 (KR) 10-2024-0132039
Jan. 7, 2025 (KR) 10-2025-0002403

(51) Int. Cl. H02M 1/44; H02M 3/158

(52) U.S. Cl. CPC H02M 1/44; H02M 3/158

(57) ABSTRACT

A power management integrated circuit (PMIC) includes a switch regulator that generates load current, and includes a first switch connected between input voltage and a switch node, and a second switch connected between ground and the switch node and a noise elimination module. The noise elimination module includes a frequency sensing block that receives a first driver control signal corresponding to turning on and off the first switch and corresponding to turning on and off the second switch, and senses a frequency of the first driver control signal, a frequency comparing block that generates a frequency difference signal by comparing the frequency with a first reference frequency, and a driver control block that generates a second driver control signal corresponding to turning on the second switch based on the frequency, and generates a third driver control signal corresponding to turning off the second switch based on the frequency difference signal.

### CROSS-REFERENCE TO RELATED APPLICATIONS

This application claims priority under 35 U.S.C. § 119 to Korean Patent Application No. 10-2024-0132039 filed on Sep. 27, 2024, and No. 10-2025-0002403 filed on Jan. 7, 2025, in the Korean Intellectual Property Office, the disclosures of which are incorporated by reference herein in their entireties.

### BACKGROUND

Embodiments of the present disclosure described herein relate to a power supply semiconductor device, and more particularly, relate to a power management integrated circuit including a noise elimination module, an operating method thereof, and an electronic device including the same.

A power management integrated circuit (PMIC) may be included in a semiconductor device to provide power to various components. The PMIC may include a voltage regulator, such as a switch regulator, to generate a target voltage. The switch regulator may provide load voltage or load current by turning on or off a switch depending on the load current of a load device connected to the PMIC.

The switch regulator may supply current continuously or discontinuously. When the switch regulator supplies current discontinuously, the frequency of the voltage of the switch regulator may enter an audible frequency range as the current consumed by the load device decreases. Because these frequencies may generate noise during the operation of the switch regulator, a method and a device for removing the noise are desired.

### SUMMARY

Embodiments of the present disclosure provide a power supply device including a noise elimination module capable of eliminating noise of audible frequency in a specific operating mode of a switch regulator.

According to an embodiment, a power management integrated circuit (PMIC) includes a switch regulator that generates load current, and including a first switch connected between input voltage and a switch node, and a second switch connected between ground voltage and the switch node, and a noise elimination module. The noise elimination module includes a frequency sensing block that receives a first driver control signal corresponding to turning on and off the first switch and corresponding to turning on and off the second switch, and senses a frequency of the first driver control signal, a frequency comparing block that generates a frequency difference signal by comparing the frequency with a first reference frequency, and a driver control block that generates a second driver control signal corresponding to turning on the second switch based on the frequency, and generates a third driver control signal corresponding to turning off the second switch based on the frequency difference signal.

According to an embodiment, an operating method of a noise elimination module included in a PMIC and connected to a switch regulator includes sensing a frequency of a first driver control signal corresponding to turning on and off each of a first switch and a second switch of the switch regulator, generating a second driver control signal corresponding to turning on the second switch when the frequency is less than a first reference frequency, and generating a third driver control signal corresponding to turning off the second switch. The first switch is connected between input voltage and a switch node, and the second switch is connected between the switch node and a ground node.

According to an embodiment, an electronic device includes a power supply unit that generates load current, and a load unit that receives the load current and operates based on the load current. The power supply unit includes a switch regulator module including a first switch connected between a power node having input voltage and a switch node, a second switch connected between the switch node and a ground node, and an inductor connected between the switch node and an output node, the load current flowing from the output node to the load unit, and a noise elimination module that senses a frequency of voltage of the switch node and controls turning on and off the second switch based on the frequency.

According to an embodiment, a PMIC includes a switch regulator that generates output voltage, and including a first switch connected between input voltage and a switch node, and a second switch connected between ground voltage and the switch node, and a noise elimination module. The noise elimination module includes a frequency sensing block that receives a first driver control signal corresponding to turning on and off each of the first switch and the second switch, and senses a frequency of the first driver control signal, and a driver control block that generates a turn-on time control signal corresponding to adjusting a length of a turn-on time of the second switch based on the frequency.

### BRIEF DESCRIPTION OF THE FIGURES

The above and other objects and features of the present disclosure will become apparent by describing in detail embodiments thereof with reference to the accompanying drawings.

FIG. 1 is a block diagram illustrating an electronic device, according to an embodiment of the present disclosure.

FIG. 2 is a block diagram showing an example of a switch regulator, according to an embodiment of the present disclosure.

FIG. 3 is a timing diagram showing an example of changes in signals over time for each operating mode of a switch regulator of FIG. 2, according to an embodiment of the present disclosure.

FIG. 4 is a block diagram showing in detail an example of a noise elimination module, according to an embodiment of the present disclosure.

FIG. 5 is a timing diagram showing an example of changes in signals of the switch regulators of FIGS. 2 and 4 over time, according to one embodiment of the present disclosure.

FIG. 6 is a flowchart showing an example of an operating method of the noise elimination module of FIG. 4, according to an embodiment of the present disclosure.

FIG. 7 is a block diagram showing in detail an example of the frequency sensing block of FIG. 4, according to an embodiment of the present disclosure.

FIG. 8 is a circuit diagram showing in detail an example of the frequency sensing block of FIGS. 4 and 7, according to an embodiment of the present disclosure.

FIG. 9 is a circuit diagram showing in detail an example of a frequency comparing block of FIG. 4, according to an embodiment of the present disclosure.

FIG. 10 is a block diagram showing in detail an example of the driver control block of FIG. 4, according to an embodiment of the present disclosure.

FIG. 11 is a circuit diagram showing in detail an example of the driver control block of FIG. 9, according to an embodiment of the present disclosure.

FIG. 12 is a timing diagram showing an example of changes in signals of the noise elimination module of FIGS. 4 to 11 and the switch regulator of FIG. 2 over time, according to an embodiment of the present disclosure.

FIG. 13 is a flowchart showing an example of an operating method of the noise elimination module of FIGS. 4 to 12 in detail, according to an embodiment of the present disclosure.

FIG. 14 is a block diagram showing a power supply unit, according to an embodiment of the present disclosure.

FIG. 15 is a timing diagram showing an example of changes in signals of the power supply unit of FIG. 14 over time, according to an embodiment of the present disclosure.

FIG. 16 is a block diagram showing a power supply unit, according to an embodiment of the present disclosure.

FIG. 17 is a block diagram showing an electronic system, according to an embodiment of the present disclosure.

FIG. 18 is a block diagram showing an electronic system, according to an embodiment of the present disclosure.

FIG. 19 is a block diagram illustrating a system, according to an embodiment of the present disclosure.

### DETAILED DESCRIPTION

Hereinafter, embodiments of the present disclosure are described in detail and clearly to such an extent that one of ordinary in the art can easily implement the invention.

As used throughout the detailed description, components described with reference to the terms “˜unit”, “module”, “block”,“˜er or ˜or”, “circuit or circuitry”, or the like and function blocks illustrated in drawings are implemented with software, hardware, or a combination thereof. In an embodiment, the software may be or include machine code, firmware, embedded code, source code, application software, and/or combinations thereof, and may be stored on a tangible, non-transitory computer-readable medium. In an embodiment, the hardware may be or include an electrical circuit, an electronic circuit (an analog circuit or a digital circuit), a processor, a computer, an integrated circuit, integrated circuit cores, a pressure sensor, an inertial sensor, a microelectromechanical system (MEMS), a passive element, and/or a combination thereof.

Terms such as “same,” “equal,” “planar,” or “coplanar,” as used herein when referring to orientation, layout, location, shapes, sizes, compositions, amounts, or other measures do not necessarily mean an exactly identical orientation, layout, location, shape, size, composition, amount, or other measure, but are intended to encompass nearly identical orientation, layout, location, shapes, sizes, compositions, amounts, or other measures within typical variations that may occur resulting from conventional manufacturing processes. The term “substantially” may be used herein to emphasize this meaning, unless the context or other statements indicate otherwise. For example, items described as “substantially the same,” “substantially equal,” or “substantially planar,” may be exactly the same, equal, or planar, or may be the same, equal, or planar within acceptable variations that may occur, for example, due to manufacturing processes.

It will be understood that, although the terms first, second, third etc. may be used herein to describe various elements, components, regions, layers and/or sections, these elements, components, regions, layers and/or sections should not be limited by these terms. Unless the context indicates otherwise, these terms are only used to distinguish one element, component, region, layer or section from another element, component, region, layer or section, for example as a naming convention. Thus, a first element, component, region, layer or section discussed below in one section of the specification could be termed a second element, component, region, layer or section in another section of the specification or in the claims without departing from the teachings of the present invention. In addition, in certain cases, even if a term is not described using “first,” “second,” etc., in the specification, it may still be referred to as “first” or “second” in a claim in order to distinguish different claimed elements from each other.

Components described herein to be connected through an active component such as a transistor or switch, and described as electrically connected based on the transistor or switch being on, may also be described as “actively electrically connected”when in that state.

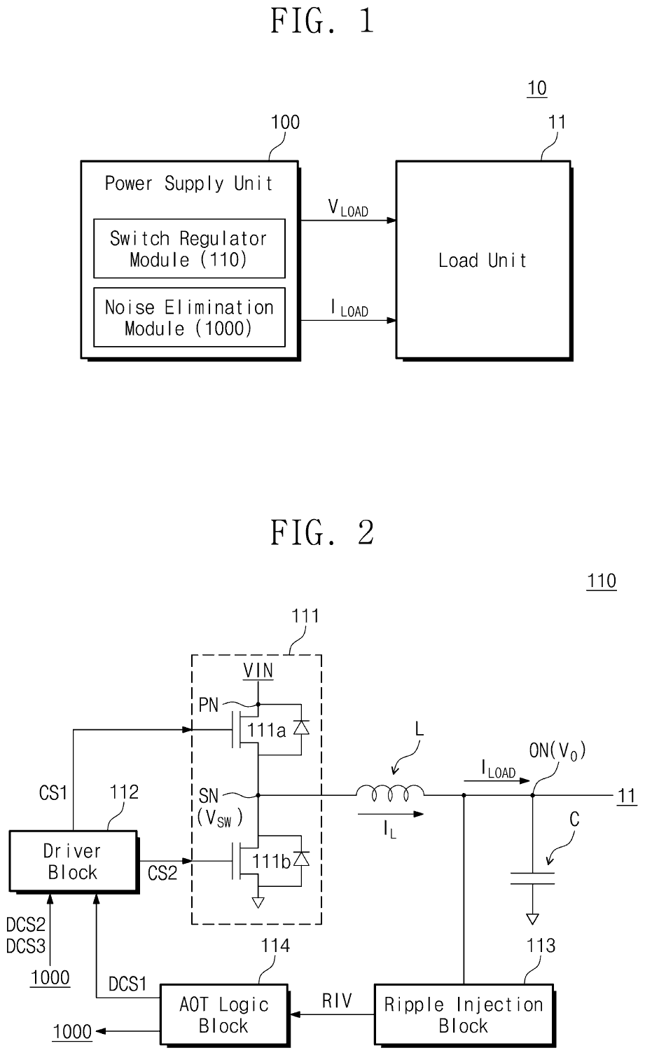

FIG. 1 is a block diagram illustrating an electronic device, according to an embodiment of the present disclosure. Referring to FIG. 1, an electronic device 10 may include a load unit 11 and a power supply unit 100. In an embodiment, the electronic device 10 may be one of various electronic devices, or may be included in various electronic devices. For example, the electronic device 10 may be one of a personal computer (PC), a smartphone, an Internet-of-things device(s), a tablet PC, a laptop PC, a personal digital assistant (PDA), a server, or a datacenter, or may be included in a personal computer (PC), a smartphone, an Internet-of-things device(s), a tablet PC, a laptop PC, a personal digital assistant (PDA), a server, or a datacenter. In an embodiment, the electronic device 10 may be or be included in a system-on-chip (SoC). In an embodiment, the electronic device 10 may be implemented as a SoC.

The load unit 11 may receive power from the power supply unit 100 and may perform various functions of the electronic device 10. The load unit 11 refers to a component of the electronic device 10 that receives an electronic load, for example, in the form of a voltage and current, and may include at least an integrated circuit, for example, formed on a semiconductor chip. For example, the load unit 11 may be a processor of the electronic device 10, and may control the overall operations of the electronic device 10 or may perform arithmetic operations necessary for the operation. It is described that the load unit 11 is a processor, but the scope of the present disclosure is not limited thereto. It should be understood that an embodiment in which the load unit 11 is a memory (e.g., a dynamic random access memory (DRAM)), an embodiment in which the load unit 11 is a display or an audio module or includes the display or the audio module, or an embodiment in which the load unit 11 includes a user input unit or a sensor unit are also within the scope of the present disclosure.

In an embodiment, the load unit 11 may receive voltage or current from the power supply unit 100. For example, the load unit 11 may receive load voltage V_{LOAD} or load current I_{LOAD} from the power supply unit 100. The load unit 11 may perform various operations by using the received load voltage V_{LOAD} or the received load current I_{LOAD}. In an embodiment, a level of the load current I_{LOAD} or a level of the load voltage V_{LOAD} may be constant or substantially constant. For example, the load current I_{LOAD} may have only a DC component, or the load voltage V_{LOAD} may have only a constant component.

The power supply unit 100 may generate power required for the operation of the electronic device 10 and may provide the power to components of the electronic device 10. In an embodiment, the power supply unit 100 may generate the load voltage V_{LOAD} or the load current I_{LOAD} and may provide the generated load voltage V_{LOAD} or the generated load current I_{LOAD} to the load unit 11.

In an embodiment, the power supply unit 100 may be a PMIC or may be included in a PMIC. In an embodiment, the power supply unit 100 may be implemented with a PMIC. Referring to FIG. 1, the power supply unit 100 may include a switch regulator module 110 and a noise elimination module 1000.

The switch regulator module 110 may generate voltage or current to be provided to the load unit 11. For example, the switch regulator module 110 may generate the load voltage V_{LOAD} or the load current I_{LOAD}. The switch regulator module 110 will be described in more detail with reference to FIG. 2.

The noise elimination module 1000 may eliminate noise generated by the operation of the power supply unit 100. In an embodiment, the noise elimination module 1000 may remove noise of a specific frequency band among noises generated due to the operation of the power supply unit 100. For example, the noise elimination module 1000 may remove noise in an audible frequency band. The noise elimination module 1000 may reduce or eliminate noise generated by the operation of the power supply unit 100 by eliminating noise in the audible frequency band.

When the level of the load current I_{LOAD} is low, the switching operation of the switch regulator module 110 may be slow, and thus, noise in the audible frequency band may occur. The configuration and operation of the noise elimination module 1000 capable of eliminating noise generated due to the operation of the switch regulator module 110 are described in detail with reference to the following drawings.

FIG. 2 is a block diagram showing an example of the switch regulator module of FIG. 1, according to an embodiment of the present disclosure. Referring to FIG. 2, the switch regulator module 110 may include a switch block 111, a driver block 112, a ripple injection block 113, an adaptive-on-time (AOT) logic block 114, an inductive element ‘L’, and a capacitive element ‘C’. A switch regulator module according to an embodiment of the present disclosure will be described with reference to FIG. 2.

The switch block 111 may generate switch voltage V_{SW} based on a switching operation. The switch voltage V_{SW} may be a voltage level of a switch node SN or may correspond to the voltage level on the switch node SN. In an embodiment, the switch block 111 may perform a switching operation in response to control signals CS1 and CS2 of the driver block 112. In an embodiment, the switch block 111 may generate the switch voltage V_{SW} from input voltage VIN. For example, the switch block 111 may generate the switch voltage V_{SW} from the input voltage VIN through a switching operation.

Referring to FIG. 2, the switch block 111 may include a first switch 111a and a second switch 111b. In an embodiment, the first switch 111a may be turned on or off in response to the first control signal CS1, and the second switch 111b may be turned on or off in response to the second control signal CS2. In an embodiment, the switches 111a and 111b may include one or more elements. For example, the first switch 111a may include a metal-oxide-semiconductor field-effect-transistor (MOSFET) connected between a power node PN and the switch node SN and operating in response to the first control signal CS1, and a diode. In this case, an anode of the diode of the first switch 111a may be connected to the switch node SN, and a cathode thereof may be connected to the power node PN. For example, the second switch 111b may include a MOSFET connected between a ground node and the switch node SN and operating in response to the second control signal CS2, and a diode. In this case, an anode of the diode of the second switch 111b may be connected to the ground node, and a cathode thereof may be connected to the switch node SN.

In an embodiment, the switches 111a and 111b may operate in response to levels of the control signals CS1 and CS2. For example, the first switch 111a may be turned on in response to the first control signal CS1 being a high level HIGH. For example, the second switch 111b may be turned on in response to the second control signal CS2 being the high level HIGH. The switches 111a and 111b in FIG. 2 are examples and the scope of the present disclosure is not limited thereto. For example, it should be understood that an embodiment in which at least some of the switches 111a and 111b do not include a diode, an embodiment in which at least some of the switches 111a and 111b further include an element, or an embodiment in which at least some of the switches 111a and 111b are turned on in response to a corresponding control signal being a low level LOW are also within the scope of the present disclosure.

The driver block 112 may control the switch block 111. In an embodiment, the driver block 112 may control the switch block 111 by transmitting the first control signal CS1 and the second control signal CS2 to the switch block 111. For example, the driver block 112 may control the first switch 111a through the first control signal CS1, and the second switch 111b through the second control signal CS2.

In response to one or more driver control signals, the driver block 112 may generate the control signals CS1 and CS2, or may transition levels of the control signals CS1 and CS2. In an embodiment, the driver block 112 may receive a first driver control signal DCS1 from the AOT logic block 114. In an embodiment, the driver block 112 may receive a second driver control signal DCS2 or a third driver control signal DCS3 from the noise elimination module 1000 of FIG. 1.

In an embodiment, the driver block 112 may generate and/or control the first control signal CS1 or the second control signal CS2 in response to the first driver control signal DCS1. For example, the driver block 112 may change a level of the first control signal CS1 to the high level HIGH in response to the first driver control signal DCS1 (e.g., in response to the first driver control signal DCS1 transitioning from a low level to a high level), and may change the level of the first control signal CS1 back to the low level LOW after a predetermined time. In an embodiment, the predetermined time may be determined based on the level of the load current I_{LOAD} provided or a user's design. After the level of the first control signal CS1 changes from the high level HIGH to the low level LOW, the driver block 112 may change the level of the second control signal CS2 to the high level HIGH, and may change the level of the second control signal CS2 back to the low level LOW after a predetermined time. The driver control signal DCS1 may be a (periodic) signal that has a particular frequency, described in more detail below.

For example, in response to the first driver control signal DCS1 (e.g., in response to a particular transition of the driver control signal), the driver block 112 may turn on the first switch 111a and may turn off the second switch 111b (or may not affect the second switch 111b so that the second switch 111b remains in its current state) during a first time, and the driver block 112 may turn off the first switch 111a and turn on the second switch 111b during a second time after (e.g., immediately after) the first time. As a result, the first driver control signal DCS1 may correspond to turning on and off the first switch 111a and may also corresponding to turning on and off the second switch 111b, which will be described further below.

In an embodiment, the driver block 112 may further control the second control signal CS2 in response to the second driver control signal DCS2 and the third driver control signal DCS3. For example, the driver block 112 may transition the level of the second control signal CS2 to the high level HIGH in response to the second driver control signal DCS2. For example, the second driver control signal DCS2 may be a signal that causes the second control signal CS2 to transition from a low level to a high level when the second driver control signal DCS2 transitions in a particular manner (e.g., from a low level to a high level). In addition, the driver block 112 may transition the level of the second control signal CS2 to the low level LOW in response to the third driver control signal DCS3. For example, the third driver control signal DCS3 may be a signal that causes the second control signal CS2 to transition from a high level to a low level when the third driver control signal DCS3 transitions in a particular manner (e.g., from a low level to a high level). Therefore, the driver block 112 may turn on the second switch 111b in response to the second driver control signal DCS2, and may turn off the second switch 111b in response to the third driver control signal DCS3. The second driver control signal DCS2 and third driver control signal DCS3 may be signals that transition based on and corresponding to the first driver control signal DCS1. For example, the second driver control signal DCS2 and third driver control signal DCS3 may be set to transition or to pulse based on a certain amount of time after the first driver control signal DCS1 transitions or pulses and/or based on a set of operations that occur due to the first driver control signal DCS1 initially changing state.

In an embodiment, the driver block 112 may maintain the second switch 111b in a turned-on state during a third time in response to the second driver control signal DCS2, and then may change the second switch 111b to be in a turned-off state. Here, the third time may be the turn-on retention time of the second switch 111b. In an embodiment, when the driver block 112 does not receive the third driver control signal DCS3 after the second driver control signal DCS2 is received (or, when it is received after the turn-on holding time has elapsed), the second switch 111b may change the second switch 111b to be in a turned-off state after the turn-on holding time has elapsed. Therefore, the second switch 111b may be turned off based on the earlier of a predetermined turn-on holding time or the receipt of the third driver control signal DCS3.

The driver control signals DCS1, DCS2, and DCS3 received by the driver block 112 are described in detail below. The aspect of operations, in which the driver block 112 generates the driver control signals DCS1, DCS2, and DCS3, is an example and the scope of the present disclosure is not limited thereto.

The ripple injection block 113 may generate ripple injected voltage RIV by sensing output voltage V_{O} and the load current I_{LOAD}. In an embodiment, a difference between the ripple injected voltage RIV and the switch voltage V_{SW} may be less than a difference between the output voltage V_{O} and the switch voltage V_{SW}. The ripple injection block 113 may improve the stability of the operation of the switch regulator module 110. In an embodiment, the ripple injection block 113 may generate the ripple corresponding to the difference between switch voltage V_{SW} and the output voltage V_{O}, which is provided to the output voltage to generate the ripple injected voltage RIV. The ripple injection block 113 may provide the ripple injected voltage RIV to the AOT logic block 114.

The AOT logic block 114 may generate the first driver control signal DCS1 based on the ripple injected voltage RIV. For example, the first driver control signal DCS1 may be a periodic signal transitioning between a low level and a high level, and the transitions may be controlled based on the ripple injected voltage RIV. In an embodiment, the AOT logic block 114 may generate the first driver control signal DCS1 based on comparing the ripple injected voltage RIV with reference voltage. For example, when the level of the ripple injected voltage RIV is lower than the level of the reference voltage, the AOT logic block 114 may generate the first driver control signal DCS1. In an embodiment, the AOT logic block 114 may be or include a comparison circuit. In an embodiment, the AOT logic block 114 generates the first driver control signal DCS1 or transit the level of the first driver control signal DCS1, when the level of the ripple injected voltage RIV is lower than the level of the reference voltage. For example, the AOT logic block 114 may include a comparator that has the ripple injected voltage RIV as an inverting input, has the reference voltage as a non-inverting input, and outputs the first driver control signal DCS1. The AOT logic block 114 may provide the generated first driver control signal DCS1 to the driver block 112 or the noise elimination module 1000 of FIG. 1.

The inductive element ‘L’ may be connected between the switch node SN and an output node ON. The output node ON may be a point connected to the load unit 11 of FIG. 1. For example, the inductive element ‘L’ may be an inductor. The inductive element ‘L’ may generate the load current I_{LOAD} from inductor current I_{L}. In an embodiment, the inductive element ‘L’ may generate the load current I_{LOAD} based on a DC component of the inductor current I_{L}. The inductor current I_{L} may be current that flows through the inductive element ‘L’ or is input or provided to the inductive element ‘L’.

The capacitive element ‘C’ may be connected between the output node ON and the ground node. In an embodiment, the capacitive element ‘C’ may be a capacitor. The capacitive element ‘C’ may accumulate and store charges on the output node ON.

The switch regulator module 110 described with reference to FIG. 2 is an example, and the scope of the present disclosure is not limited thereto. It should be understood that an embodiment in which the switch regulator module 110 does not include some of the blocks illustrated in FIG. 2, or does not generate some of the signals, is also within the scope of the present disclosure.

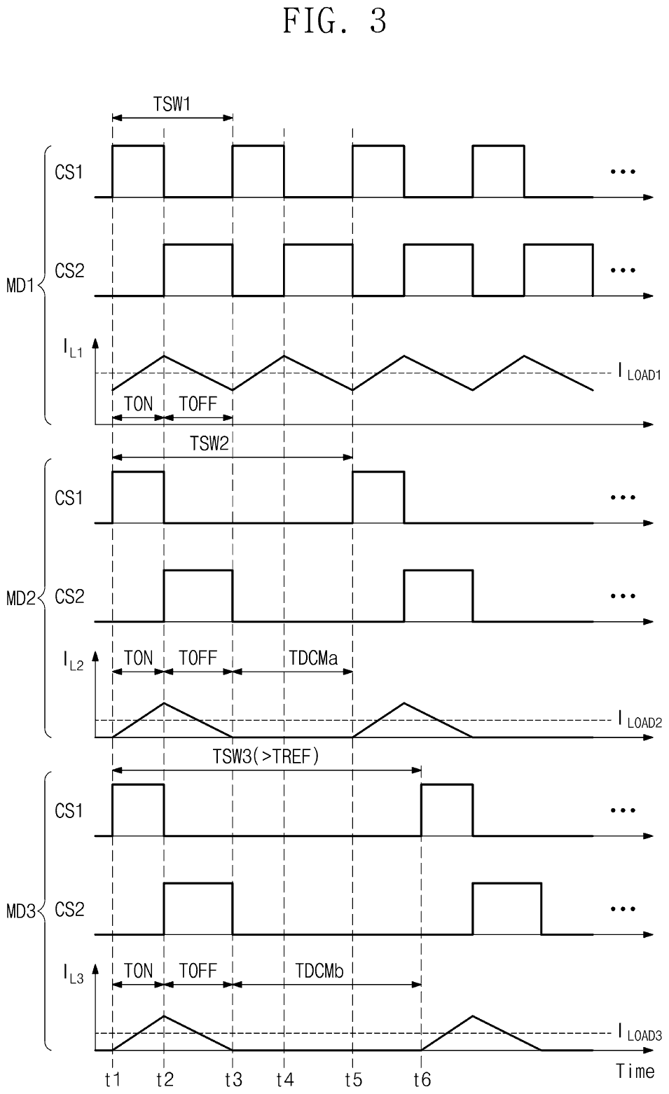

FIG. 3 is a timing diagram showing an example of changes in signals over time for each operating mode of the switch regulator module of FIG. 2, according to an embodiment of the present disclosure. Referring to FIG. 3, changes in levels of the first control signal CS1, the second control signal CS2, and inductor currents I_{L1}, I_{L2}, and I_{L3} over time of each of modes MD1, MD2, and MD3 of the switch regulator module 110 of FIG. 2 are illustrated. Operations according to the modes MD1, MD2, and MD3 of the switch regulator module 110 are described with reference to FIGS. 2 and 3.

Each of load currents I_{LOAD1}, I_{LOAD2}, and I_{LOAD3} may be the load current I_{LOAD} of FIG. 1 or may correspond to the load current I_{LOAD} of FIG. 1. Each of the load currents I_{LOAD1}, I_{LOAD2}, and I_{LOAD3} may be generated based on the corresponding inductor currents I_{L1}, I_{L2}, and I_{L3}. For example, each of the load currents I_{LOAD1}, I_{LOAD2}, and I_{LOAD3} may be generated based on the corresponding inductor currents I_{L1}, I_{L2}, and I_{L3} passing through the inductive element ‘L’ of FIG. 2.

The first mode MD1 may be a continuous current mode. For example, the switch regulator module 110 may continuously output current in the first mode MD1. Referring to FIG. 3, the first control signal CS1 may be changed to the high level HIGH at a first time point t1, and may return to the low level LOW again at a second time point t2. The first switch 111a may be turned on in response to the first control signal CS1 of the high level HIGH. As the first switch 111a is turned on, the level of the first inductor current I_{L1} may increase. The time between the first time point t1 and the second time point t2 may be an on time TON.

The second control signal CS2 may be changed to the high level HIGH at the second time point t2, and may return to the low level LOW at a third time point t3. The second switch 111b may be turned on in response to the second control signal CS2 of the high level HIGH. As the second switch 111b is turned on, the level of the first inductor current I_{L1} may decrease. The time between the second time point t2 and the third time point t3 may be an off time TOFF.

After the third time point t3, the switch regulator module 110 may repeat the operations between the first time point t1 and the third time point t3. After the third time point t3, the first inductor current I_{L1} may change in a method identical or similar to the change aspect between the first time point t1 and the third time point t3.

The second mode MD2 and the third mode MD3 may be a discontinuous current mode (DCM). From the first time point t1 to the second time point t2, the first switch 111a of the second mode MD2 may be turned on in response to the first control signal CS1 of the high level HIGH, and the second inductor current I_{L2} may increase in response to the first switch 111a being turned on. The time between the first time point t1 and the second time point t2 may be the on time TON.

From the second time point t2 to the third time point t3, the second switch 111b of the second mode MD2 may be turned on in response to the second control signal CS2 of the high level HIGH, and the second inductor current I_{L2} may decrease in response to the second switch 111b being turned on. The time between the first time point t1 and the second time point t2 may be the off time TOFF.

An interval between the third time point t3 and a fifth time point t5 may be a discontinuous current mode time TDCMa of the second mode. In the discontinuous current mode time TDCMa, both the first control signal CS1 and the second control signal CS2 may be in a state of the low level LOW. During the discontinuous current mode time TDCMa, the level of the second inductor current I_{L2} may be ‘0’. After the fifth time point t5 in the second mode MD2, the switch regulator module 110 may repeat operations identical or similar to the operations from the first time point t1 to the fifth time point t5.

The level of the third load current I_{LOAD3} of the third mode MD3 may be lower than the level of the second load current I_{LOAD2} of the second mode MD2. In an embodiment, the second mode MD2 and the third mode MD3 may be selected depending on the operating mode of the load unit 11 of FIG. 1. For example, the second mode MD2 may correspond to a normal mode of the electronic device 10 of FIG. 1, and the third mode MD3 may correspond to a sleep mode of the electronic device 10 of FIG. 1.

From the first time point t1 to the second time point t2, the first switch 111a of the third mode MD3 may be turned on in response to the first control signal CS1 of the high level HIGH, and the third inductor current I_{L3} may increase in response to the first switch 111a being turned on. The time between the first time point t1 and the second time point t2 may be the on time TON.

From the second time point t2 to the third time point t3, the second switch 111b of the third mode MD3 may be turned on in response to the second control signal CS2 of the high level HIGH, and the third inductor current I_{L3} may decrease in response to the second switch 111b being turned on. The time between the first time point t1 and the second time point t2 may be the off time TOFF.

From the third time point t3 to a sixth time point t6 may be a discontinuous current mode time TDCMb of the third mode MD3. In the discontinuous current mode time TDCMb, both the first control signal CS1 and the second control signal CS2 may be in a state of the low level LOW. During the discontinuous current mode time TDCMb, the level of the second inductor current I_{L2} may be ‘0’. After the fifth time point t5 in the second mode MD2, the switch regulator module 110 may repeat operations identical or similar to the operations from the first time point t1 to the fifth time point t5.

The switch regulator module 110 may repeat operations at each period in each of the modes MD1, MD2, and MD3, and may have a switching period accordingly. The switch regulator module 110 may have a first switch period TSW1 corresponding to a time between the first time point t1 and the third time point t3 in the first mode MD1, may have a second switch period TSW2 corresponding to a time between the first time point t1 and the fifth time point t5 in the second mode MD2, and may have a third switch period TSW3 corresponding to a time between the first time point t1 and the sixth time point t6 in the third mode MD3.

In an embodiment, the reciprocal of each of the first switch period TSW1 and the second switch period TSW2 may be greater than the audible frequency (the maximum value). Noise caused by the switching operation of the switch regulator module 110 may not be sensed by a user. On the other hand, the reciprocal of the third switch period TSW3 may be included within an audible frequency range. The reason is that as the third mode MD3 may be in a sleep mode and the magnitude of the third load current I_{LOAD3} required by the load unit 11 is small, the required energy is less, thereby lengthening the switching period.

Accordingly, the third switch period TSW3 may be larger than a reference period TREF corresponding to the audible frequency. In this case, the user may detect noise according to a switching operation of the switch regulator module 110 of the third mode MD3. The switch regulator module 110 or the power supply unit 100 of FIG. 1, which is capable of providing a load current at a level equal to or lower than the third load current I_{LOAD3} while reducing or eliminating such the noise, is described in detail with reference to the following drawings.

The time points t1 to t6 shown in FIG. 3 should be understood as indicating the order of operations. Intervals between the time points t1 to t6 shown in FIG. 3 are examples for convenience of description, and the scope of the present disclosure is not limited thereto. For example, the intervals between the time points t1 to t6 may not correspond to the actual time between the time points. The waveforms and levels of the graphs in FIG. 3 are examples and the scope of the present disclosure is not limited thereto. For convenience of explanation and illustration, it should be understood that the waveforms, shapes or time point-specific levels of the graphs may be illustrated and described in an exaggerated manner.

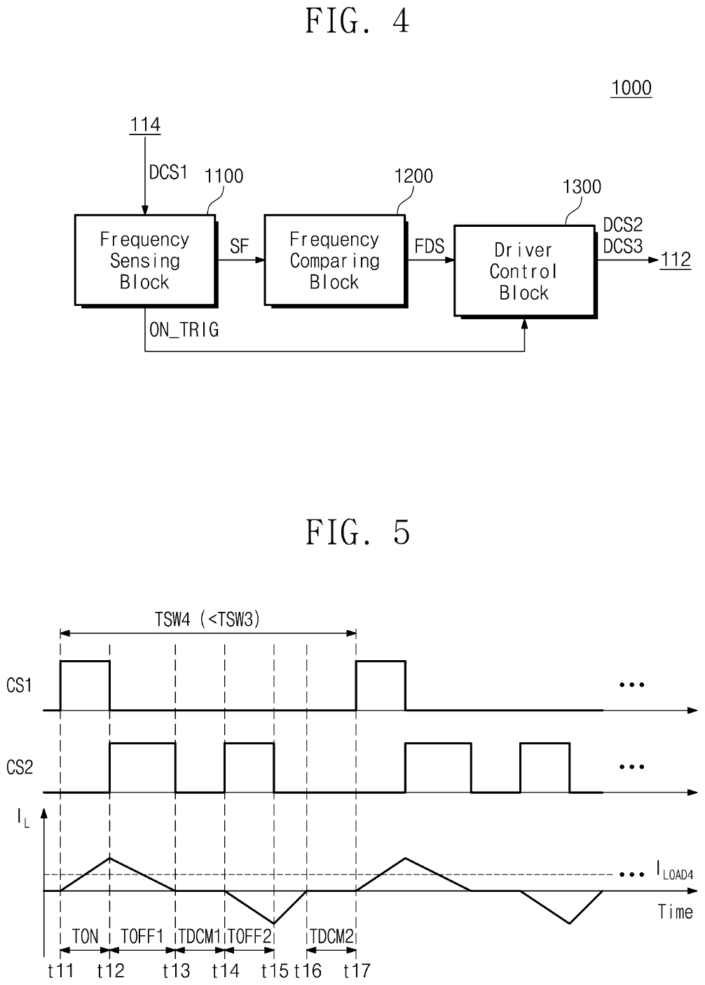

FIG. 4 is a block diagram showing in detail an example of the noise elimination module of FIG. 1, according to an embodiment of the present disclosure. Referring to FIG. 4, the noise elimination module 1000 may include a frequency sensing block 1100, a frequency comparing block 1200, and a driver control block 1300. The noise elimination module according to an embodiment of the present disclosure will be described in detail with reference to FIGS. 1, 2, and 4.

The frequency sensing block 1100 may detect the frequency of the switch voltage V_{SW} of FIG. 2. In an embodiment, the frequency sensing block 1100 may detect the frequency of the switch voltage V_{SW} based on the first driver control signal DCS1. For example, the frequency sensing block 1100 may detect the frequency of the switch voltage V_{SW} based on detecting an interval between time points when the level of the first driver control signal DCS1 transitions to the high level HIGH, which may correspond to the frequency of the switch voltage V_{SW}. For example, each transition of the first driver control signal DCS1 from low to high may cause the first control signal CS1 to transition from low to high, which may turn on the switch 111a, so that the on-off cycle of the switch 111a has the same period as the period of the first driver control signal DCS1.

In an embodiment, the frequency sensing block 1100 may detect and sample the frequency of the switch voltage V_{SW} and may generate a sampling frequency SF. A value indicated by the detected frequency may be the frequency of the switch voltage V_{SW} or may correspond to the frequency of the switch voltage V_{SW}. The value may also correspond to the detected interval between time points when the level of the first driver control signal DCS1 transitions to the high level HIGH, so that the frequency of the first driver control signal DCS1 matches the frequency of the switch voltage V_{SW}. In an embodiment, the frequency sensing block 1100 may provide the sampling frequency SF to the frequency comparing block 1200.

The frequency sensing block 1100 may generate an on-trigger signal ON_TRIG based on the first driver control signal DCS1. In an embodiment, the frequency sensing block 1100 may generate and control the on-trigger signal ON_TRIG based on comparing the frequency of the switch voltage V_{SW} with a first reference frequency. For example, when the frequency of the switch voltage V_{SW} is less than a first reference frequency, the frequency sensing block 1100 may generate and control the on-trigger signal ON_TRIG, for example to have or transition to a particular state (e.g., high) or to begin a periodic cyclical on-off pattern. In an embodiment, the frequency sensing block 1100 may generate the on-trigger signal ON_TRIG based on the sampling frequency SF. For example, the frequency sensing block 1100 may compare the sampling frequency SF with the first reference frequency. When the sampling frequency SF is smaller than the first reference frequency, the frequency sensing block 1100 may generate the on-trigger signal ON_TRIG, for example to be in a high state or to begin a periodic cyclical on-off pattern. Generating the on-trigger ON_TRIG refers to causing a signal transmitted from the frequency sensing block 1100 directly to the driver control block 1300 to have a particular value or pattern (e.g., a trigger signal may be set to a particular state or level that corresponds to the on-trigger ON_TRIG).

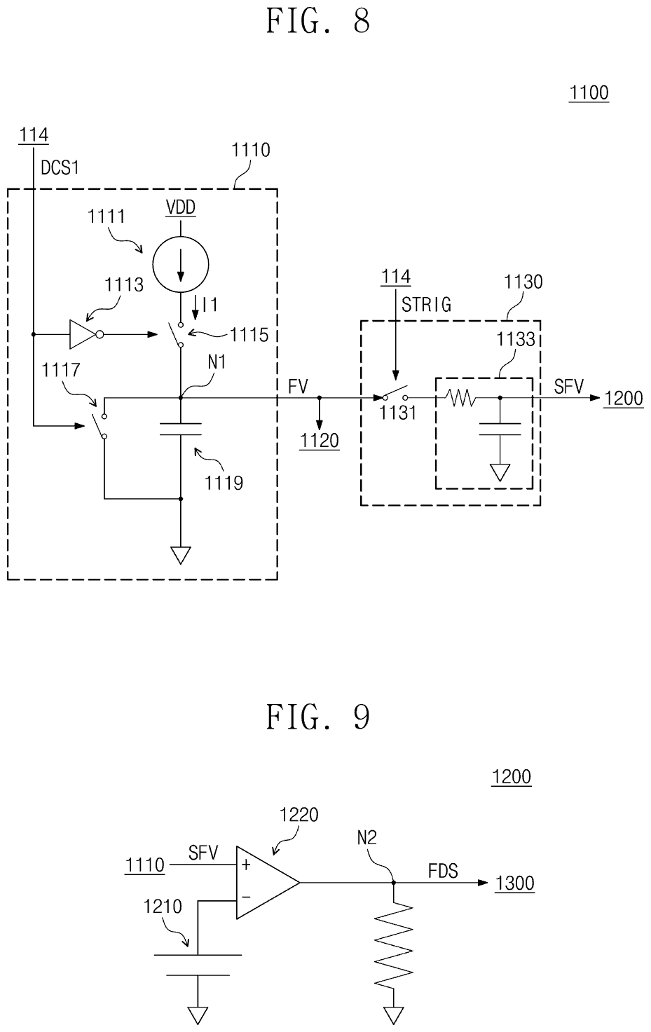

The frequency sensing block 1100 may transmit the generated on-trigger ON_TRIG to the driver control block 1300. The detailed structure and operation of the frequency sensing block 1100 will be described with reference to FIGS. 7 and 8.

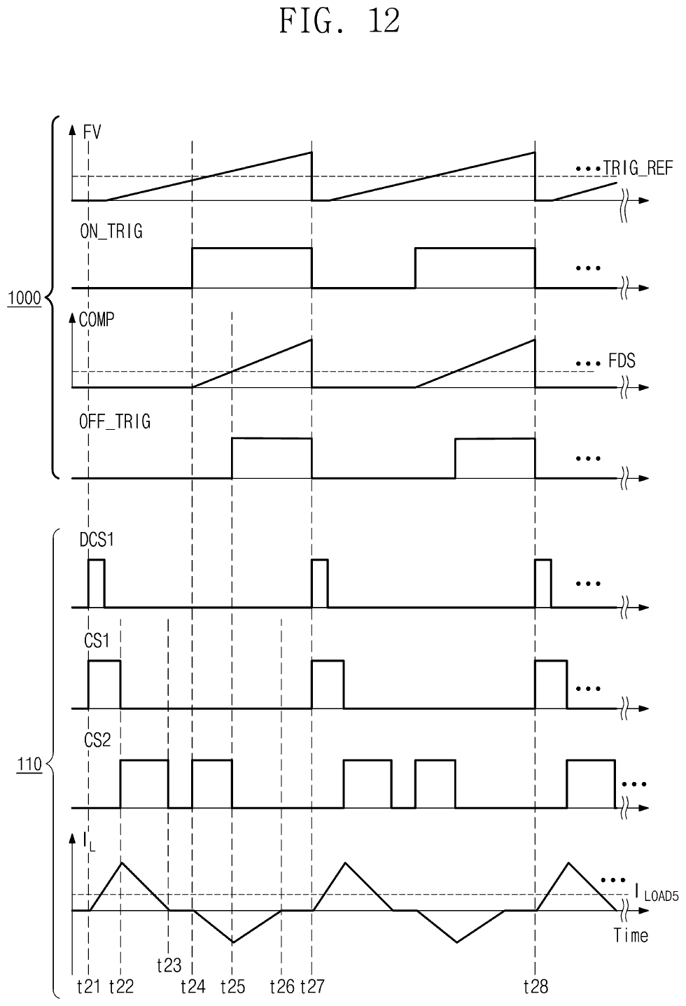

The frequency comparing block 1200 may compare the sampling frequency SF with a second reference frequency. In an embodiment, the second reference frequency may correspond to the time difference between the second driver control signal DCS2 and the third difference signal. In another embodiment, the second reference frequency corresponds to the time at which the second switch 111b is turned on when the inductor current flows form the output node ON to the switch node SN. In an embodiment, the frequency comparing block 1200 may generate a frequency difference signal FDS based on the sampling frequency SF. For example, the frequency comparing block 1200 may generate the frequency difference signal FDS by generating a difference between the sampling frequency SF and the second reference frequency. The frequency difference signal FDS may be a signal used to generate an off-trigger signal OFF_TRIG described later. The detailed structure and operation of the frequency comparing block 1200 will be described with reference to FIG. 11.

The driver control block 1300 may generate one or more driver control signals. For example, the driver control block 1300 may generate the second driver control signal DCS2 or the third driver control signal DCS3. In an embodiment, the second driver control signal DCS2 may correspond to turning on the second switch 111b, and the third driver control signal DCS3 may correspond to turning off the second switch 111b. In an embodiment, the second driver control signal DCS2 may correspond to turning on the second switch 111b during a specific time (e.g., turn-on retention time).

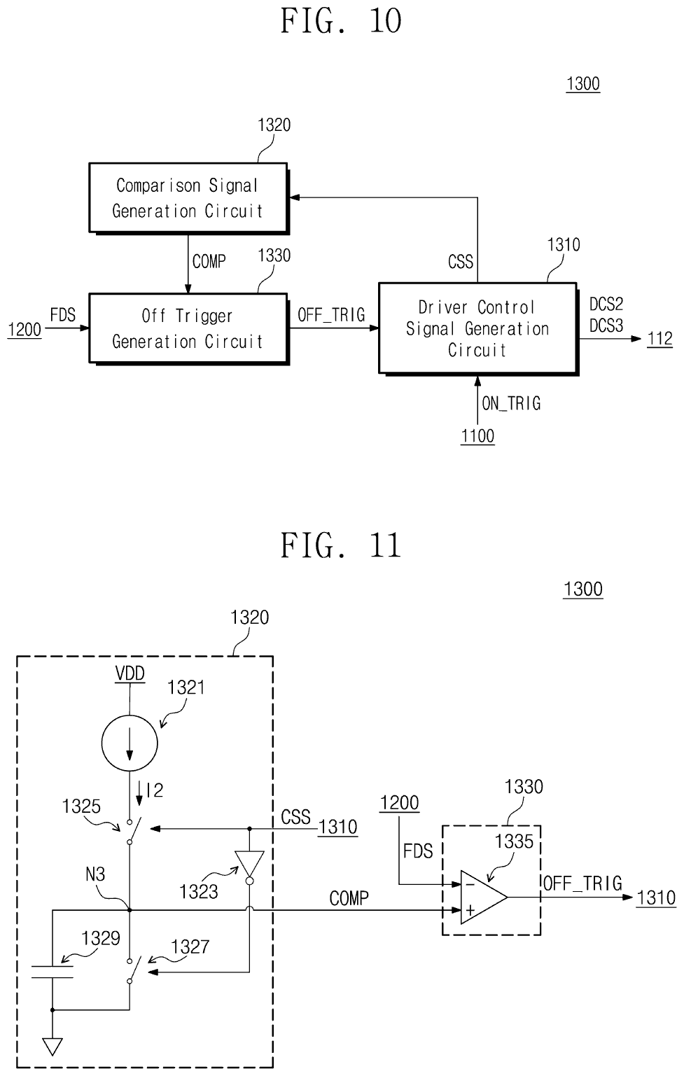

In an embodiment, the driver control block 1300 may generate the driver control signals DCS2 and DCS3 based on signals received from the frequency comparing block 1200. For example, the driver control block 1300 may generate the second driver control signal DCS2 in response to the on-trigger ON_TRIG received from the frequency sensing block 1100. For another example, the driver control block 1300 may generate the third driver control signal DCS3 based on the frequency difference signal FDS received from the frequency comparing block 1200. The detailed structure and operation of the driver control block 1300 will be described in more detail with reference to FIGS. 9 and 10.

The blocks in FIG. 4 and operations of the blocks are examples and should not be construed as limiting the scope of the present disclosure. For example, an embodiment in which the driver control block 1300 receives the on-trigger ON_TRIG, generates the second driver control signal DCS2, and after an arbitrary (e.g., predetermined) time, generates the third driver control signal DCS3 may also fall within the scope of the present disclosure. (In this case, the noise elimination module 1000 may not generate the sampling frequency SF or the frequency difference signal FDS.) It should be understood that embodiments that do not include at least some of the blocks illustrated in FIG. 4 are also within the scope of the present disclosure. For example, an embodiment in which the noise elimination module 1000 does not include the frequency comparing block 1200 may also fall within the scope of the present disclosure.

FIG. 5 is a graph showing an example of changes in signals of the switch regulators of FIGS. 2 and 4 over time, according to one embodiment of the present disclosure. Referring to FIG. 5, changes in levels of the control signals CS1 and CS2 over time and changes in a level of the inductor current I_{L} over time are shown. An example of the operation of the switch regulator module 110 connected to the noise elimination module 1000 will be described with reference to FIGS. 1 to 5.

The fourth load current I_{LOAD4} may be the load current I_{LOAD} of FIG. 1 or may correspond to the load current I_{LOAD} of FIG. 1. The fourth load current I_{LOAD4} may be generated based on the inductor current I_{L}. For example, the fourth load current I_{LOAD4} may be generated based on the inductor current I_{L} of FIG. 5 passing through the inductive element ‘L’ of FIG. 2.

From an eleventh time point t11 to a thirteenth time point t13, the switch regulator module 110 may operate in the same or similar manner as the operation(s) of the first to third time points t1 to t3 of the switch regulator module 110 in the second mode MD2 or the third mode MD3 of FIG. 3. The eleventh and twelfth time points t11 and t12 may correspond to the on time TON; the first control signal CS1 may have the high level HIGH; and, the second control signal CS2 may have the low level LOW. As the first switch 111a is turned on in response to the first control signal CS1 of the high level HIGH, the level of the inductor current I_{L} may increase.

The twelfth and thirteenth time points t12 and t13 may correspond to a first off time TOFF1; the first control signal CS1 may have the low level LOW; and, the second control signal CS2 may have the high level HIGH. As the second switch 111b is turned on in response to the second control signal CS2 of the high level HIGH, the level of the inductor current I_{L} may decrease. In an embodiment, the level of the inductor current I_{L} may be ‘0’ at the thirteenth time point t13.

From the thirteenth time point t13 to a fourteenth time point t14, the inductor current I_{L} may be maintained at zero level during a first discontinuous current mode time TDCM1. The levels of the first control signal CS1 and the second control signal CS2 may be maintained at the low level LOW during the first discontinuous current mode time TDCM1. The second control signal CS2 may be changed to the high level HIGH at the fourteenth time point t14. In an embodiment, the switch regulator module 110 may change the level of the second control signal CS2 to the high level HIGH in response to the second driver control signal DCS2 at the fourteenth time point t14.

In an embodiment, the noise elimination module 1000 may generate the second driver control signal DCS2 at the fourteenth time point t14 (or before the fourteenth time point t14) based on the first driver control signal DCS1 received at or before the eleventh time point t11. For example, the frequency sensing block 1100 may receive the first driver control signal DCS1 at the eleventh time point t11, may generate the on-trigger signal ON_TRIG between the eleventh time point t11 and the fourteenth time point t14, and may transmit the on-trigger signal ON_TRIG to the driver control block 1300. The driver control block 1300 may receive the on-trigger signal ON_TRIG at the fourteenth time point t14, may generate the second driver control signal DCS2, and may transmit the second driver control signal DCS2 to the driver control block 112.

An interval between the fourteenth and fifteenth time points t14 and t15 may be a second off time TOFF2. During the second off time TOFF2, the first control signal CS1 may maintain the low level LOW, and the second control signal CS2 may maintain the high level HIGH. The level of the inductor current I_{L} may increase as the second switch 111b is turned on. A direction of the inductor current I_{L} may be opposite to a direction of the inductor current I_{L} at the first off time TOFF1. The second control signal CS2 may transition to the low level LOW at the fifteenth time point t15.

In an embodiment, the noise elimination module 1000 may generate the third driver control signal DCS3 at the fifteenth time point t15 based on the frequency difference signal FDS. For example, the frequency comparing block 1200 may generate the frequency difference signal FDS before the fifteenth time point t15 and may deliver the frequency difference signal FDS to the driver control block 1300. The driver control block 1300 may generate the third driver control signal DCS3 based on the frequency difference signal FDS at the fifteenth time point t15.

The level of the inductor current I_{L} may decrease between the fifteenth time point t15 and the sixteenth time point t16. The inductor current I_{L} may be returned to the input voltage VIN source through the diode of the first switch 111a between the fifteenth time point t15 and the sixteenth time point t16. (In this case, some of the energy received from the input voltage VIN may be returned to the input voltage VIN source, and the energy efficiency of the switch regulator module 110 may increase.) The level of the inductor current I_{L} may be ‘0’ at the sixteenth time point t16.

An interval between the sixteenth and seventeenth time points t16 and t17 may be a second discontinuous current mode time TDCM2. The levels of both the first control signal CS1 and the second control signal CS2 may be the low level LOW during the second discontinuous current mode time TDCM2. The level of the inductor current I_{L} may be maintained at ‘0’ during the second discontinuous current mode time TDCM2.

The switch regulator module 110 may receive the first driver control signal DCS1 again at the seventeenth time point t17. After the seventeenth time point t17, the switch regulator module 110 and the noise elimination module 1000 may perform or repeat operation(s) identical or similar to the operations of the eleventh time point t11 to the seventeenth time point t17.

In an embodiment, before the eleventh time point t11, the switch regulator module 110 or the noise elimination module 1000 may perform a preceding operation for performing the operations of FIG. 5. For example, before the eleventh time point t11, the switch regulator module 110 and the noise elimination module 1000 may precede all or part of operations for obtaining a time interval between the fourteenth time point t14 and the fifteenth time point t15. For another example, the switch regulator module 110 or the noise elimination module 1000 may perform at least part of the operations described with reference to FIG. 5. For example, after the transition of the first control signal CS1 is restored, the switch regulator module 110 and the noise elimination module 1000 may precede some or all of operation(s) for generating or determining the length of time, in which the second control signal CS2 is maintained in the second transition state, prior to the eleventh time point t11.

The level of the fourth load current I_{LOAD4} may be equal or substantially equal to or less than the level of the third load current I_{LOAD3} in FIG. 3. The interval between the eleventh time point t11 and the seventeenth time point t17 of FIG. 5 may be a fourth switch period TSW4, and may be shorter than the third switch period TSW3 in FIG. 3, for example, because the level of the output voltage V_{O} may rapidly decrease due to an operation of the second switch 111b, and thus the time required for the first driver control signal DCS1 to be regenerated may decrease.

In an embodiment, the fourth switch period TSW4 may be shorter than the reference period TREF in FIG. 3. As a result, the switch regulator module 110 and the noise elimination module 1000 may eliminate noise caused by the switch voltage V_{SW} based on the operation of FIG. 5. Accordingly, the switch regulator module 110 and the noise elimination module 1000 may eliminate noise caused by operation regardless of the magnitude of load current.

The signals and changes in signals over time, which are illustrated and described in FIG. 5, and the operation(s) of the switch regulator module 110 and the noise elimination module 1000, are examples, and the scope of the present disclosure is not limited thereto. The time points t11 to t17 shown in FIG. 5 are used to indicate the order of operations, and the intervals between the time points t11 to t17 do not necessarily correspond to the actual time required to perform the operations. It should be understood that the waveforms and the levels in the graph of FIG. 5 are examples and may be exaggerated to some extent for convenience of description.

In FIG. 5, it is described that some or all of the operations of the switch regulator module 110 or the noise elimination module 1000 are performed simultaneously at each of the time points t11 to t17, but this is an example and the scope of the present disclosure is not limited thereto. In an embodiment, at each of the corresponding time points t11 to t17, at least all or part of the operations of the switch regulator module 110 or the noise elimination module 1000 may be performed sequentially or in parallel. For example, operations (or at least some of the operations) of the switch regulator module 110 or the noise elimination module 1000 required for the level of the second control signal CS2 at the fourteenth time point t14 to transition to the high level HIGH may be performed (e.g., sequentially) before the fourteenth time point t14. It should be understood that the operations (or at least part of the operations) of the switch regulator module 110 or the noise elimination module 1000 at each of the time points t11 to t17 may be performed before or after each of the time points t11 to t17.

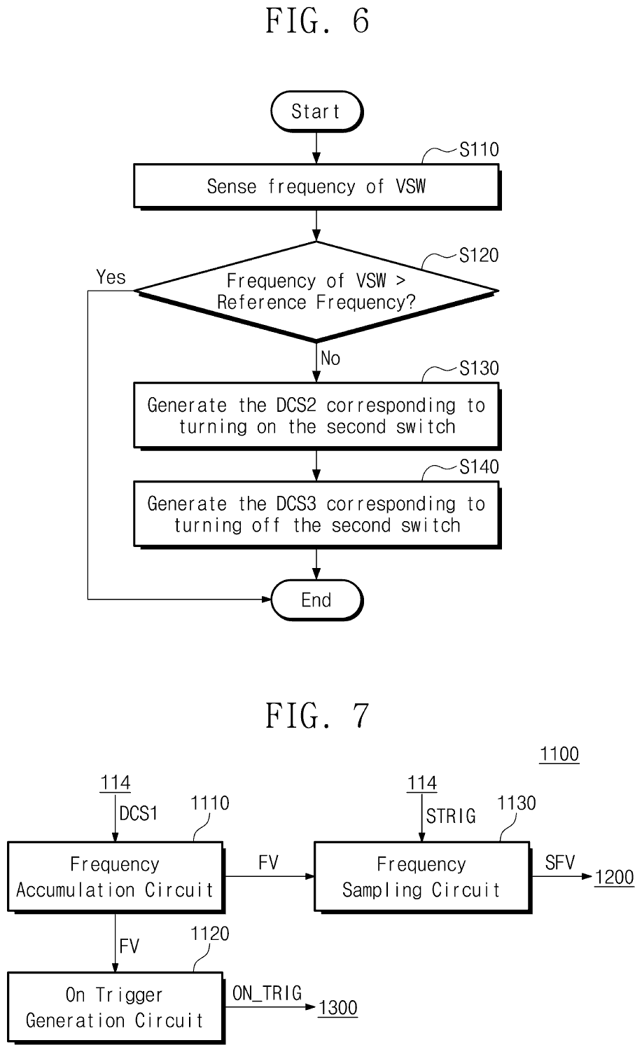

FIG. 6 is a flowchart showing an example of an operating method of the noise elimination module of FIGS. 4 and 5, according to an embodiment of the present disclosure.

In operation S110, the noise elimination module 1000 may sense the frequency of the switch voltage V_{SW} of FIG. 2. For example, the noise elimination module 1000 may receive the first driver control signal DCS1 from the AOT logic block 114 of FIG. 2. The noise elimination module 1000 may sense the frequency of the switch voltage V_{SW} based on sensing the frequency of the first driver control signal DCS1.

In operation S120, the noise elimination module 1000 may determine the next operation depending on the frequency of the switch voltage V_{SW}. When the frequency of the switch voltage V_{SW} is higher than a reference frequency, the noise elimination module 1000 may terminate the operations. On the other hand, when the frequency of the switch voltage V_{SW} is equal to or lower than the reference frequency, the noise elimination module 1000 may proceed to operation S130. In an embodiment, the reference frequency may be the maximum value of an audible frequency or a frequency greater than the maximum value of the audible frequency. For example, the reference frequency may be 20 kHz.

In operation S130, the noise elimination module 1000 may generate the second driver control signal DCS2 corresponding to turning on the second switch 111b of FIG. 2. For example, similarly to the operation at the fourteenth time point t14 in FIG. 5, the noise elimination module 1000 may generate the second driver control signal DCS2. For a more detailed example, the driver control block 1300 may generate the second driver control signal DCS2 in response to the on-trigger ON_TRIG transmitted by the frequency sensing block 1100. In an embodiment, the noise elimination module 1000 may transmit the generated second driver control signal DCS2 to the driver block 112 of FIG. 2. The noise elimination module 1000 may terminate the operation(s) in operation S130 and then may proceed to operation S140.

In operation S140, the noise elimination module 1000 may generate the third driver control signal DCS3 corresponding to turning off the second switch 111b of FIG. 2. For example, similarly to the operation at the fifteenth time point t15 in FIG. 5, the noise elimination module 1000 may generate the third driver control signal DCS3. For a more detailed example, the driver control block 1300 may generate the third driver control signal DCS3 based on the frequency difference signal FDS generated by the frequency comparing block 1200. In an embodiment, the noise elimination module 1000 may transmit the generated third driver control signal DCS3 to the driver block 112 of FIG. 2.

In an embodiment, there may be a time difference between the generation time point of the second driver control signal DCS2 in operation S130 and the generation time point of the third driver control signal DCS3 in operation S140. For example, the time difference between the second driver control signal DCS2 generation time point in operation S130 and the third driver control signal DCS3 generation time point in operation S140 may be the same or substantially the same as or may correspond to a time difference between the fourteenth time point t14 and the fifteenth time point t15.

The noise elimination module 1000 may terminate the operations after operation S140. In an embodiment, after operation S140, the noise elimination module 1000 may return to operation S110 and may repeat the operations. The sequence of operations illustrated and described in FIG. 6 is an example and the scope of the present disclosure is not limited thereto. In an embodiment, at least part of the operations of FIG. 6 may be performed while being overlapped. For example, at least part of the operations of operation S130 and operation S140 may be performed while being overlapped.

FIG. 7 is a block diagram showing in detail an example of the frequency sensing block of FIG. 4, according to an embodiment of the present disclosure. The frequency sensing block 1100 may correspond to the frequency sensing block 1100 of FIG. 4. Referring to FIG. 7, the frequency sensing block 1100 may include a frequency accumulation circuit 1110, an on trigger generation circuit 1120, and a frequency sampling circuit 1130. The frequency sensing block 1100 will be described in detail with reference to FIGS. 4 to 7.

The frequency accumulation circuit 1110 may perform a frequency accumulation operation. In an embodiment, the frequency accumulation circuit 1110 may accumulate voltage corresponding to the frequency of the switch voltage V_{SW} of FIG. 2. For example, the frequency accumulation circuit 1110 may accumulate voltage corresponding to the frequency of the switch voltage V_{SW} of FIG. 2 in response to the first driver control signal DCS1. In an embodiment, after starting a frequency accumulation operation, the frequency accumulation circuit 1110 may initialize the accumulated voltage in response to the first driver control signal DCS1 being received, and may accumulate new voltage corresponding to the frequency of the switch voltage V_{SW}.

The frequency accumulation circuit 1110 may generate frequency voltage FV in response to the first driver control signal DCS1. In an embodiment, the frequency accumulation circuit 1110 may perform an accumulation operation of the frequency voltage FV simultaneously with receiving the first driver control signal DCS1. In an embodiment, as the frequency of the switch voltage V_{SW} increases, the maximum value of the level of the frequency voltage FV may be small. The reason is that when the frequency of the switch voltage V_{SW} increases, the interval at which the first driver control signal DCS1 is received decreases and the time for the voltage to be accumulated decreases.

The frequency accumulation circuit 1110 may deliver the generated frequency voltage FV to other circuits. For example, the frequency accumulation circuit 1110 may deliver the frequency voltage FV to the on trigger generation circuit 1120 or the frequency sampling circuit 1130. The detailed structure of the frequency accumulation circuit 1110 will be described with reference to FIG. 8.

The on trigger generation circuit 1120 may generate the on-trigger signal ON_TRIG based on the frequency voltage FV. In an embodiment, the on trigger generation circuit 1120 may generate an on-trigger signal based on a comparison between the frequency voltage FV and a frequency reference voltage. For example, the on trigger generation circuit 1120 may generate the on-trigger signal ON_TRIG at a time point when the frequency voltage FV accumulated by the frequency accumulation circuit 1110 is greater than the frequency reference voltage.

In an embodiment, the on trigger generation circuit 1120 may determine the level of the on-trigger signal ON_TRIG based on the frequency voltage FV. For example, when the frequency voltage FV is greater than the frequency reference voltage, the on trigger generation circuit 1120 may maintain the level of the on-trigger signal ON_TRIG at the high level HIGH or may transition the level of the on-trigger signal ON_TRIG to the high level HIGH. However, this is an example and the scope of the present disclosure is not limited thereto. An embodiment in which the on-trigger signal ON_TRIG transitions to the low level LOW or is maintained at the low level LOW in response to the frequency voltage FV being greater than the frequency reference voltage may also fall within the scope of the present disclosure.

In an embodiment, the on trigger generation circuit 1120 may include a comparator that compares the frequency voltage FV with a frequency comparison voltage. For example, the on trigger generation circuit 1120 may include a comparator that receives the frequency voltage FV as a non-inverting input, receives the frequency comparison voltage as an inverting input, and outputs the on-trigger signal ON_TRIG. In an embodiment, the frequency reference voltage may correspond to the reference period TREF of FIG. 3. For example, the frequency reference voltage may be voltage accumulated as much as a reciprocal of the reference period TREF, or may correspond to voltage accumulated as much as the reciprocal of the reference period TREF. For a more detailed example, the frequency reference voltage may correspond to the maximum value of an audible frequency.

In an embodiment, the on trigger generation circuit 1120 may provide the generated on-trigger signal ON_TRIG to the driver control block 1300 of FIG. 4. Detailed examples of the on-trigger signal ON_TRIG will be described with reference to FIG. 12.

The frequency sampling circuit 1130 may sample the frequency voltage FV. In an embodiment, the frequency sampling circuit 1130 may sample the frequency voltage FV in response to a sampling trigger STRIG received from the AOT logic block 114 of FIG. 2. For example, the frequency sampling circuit 1130 may generate the sampled frequency voltage SFV by sampling the frequency voltage FV in response to the sampling trigger STRIG being at the high level HIGH. The sampled frequency voltage SFV may correspond to the sampling frequency SF of FIG. 7. In an embodiment, the level of the sampled frequency voltage SFV may be the maximum value (e.g., after initialization) of the level of the accumulated frequency voltage FV, or may be (e.g., substantially) the same as the maximum.

In an embodiment, the sampling trigger STRIG may correspond to the first driver control signal DCS1. For example, the sampling trigger STRIG may be the same as the first driver control signal DCS1. For example, the level of the sampling trigger STRIG may be the same as the level of the first driver control signal DCS1. In an embodiment, the timing at which the level of the sampling trigger STRIG is transitioned may be the same or substantially the same as the timing at which the level of the first driver control signal DCS1 is transitioned.

The frequency sampling circuit 1130 may transmit the sampled frequency voltage SFV to the frequency comparing block 1200 of FIG. 4. The sampled frequency voltage SFV and the sampling trigger STRIG will be described in more detail with reference to FIG. 8.

The frequency sensing block 1100 described with reference to FIG. 7 is an example, and the scope of the present disclosure is not limited thereto. The circuits 1110, 1120, and 1130 described in FIG. 7 may be divisions for convenience of description or functional divisions. The present disclosure should not be construed as being limited to an embodiment in which the frequency sensing block 1100 is implemented through the circuits 1110, 1120, and 1130. It should be understood that an embodiment in which the frequency sensing block 1100 does not include some of the circuits 1110, 1120, and 1130, an embodiment in which each of the circuits 1110, 1120, and 1130 does not perform at least some of the functions or operations described with reference to FIG. 7, or an embodiment in which at least some or all of the functions or operations of each of the circuits 1110, 1120, and 1130 are performed by other of the circuits 1110, 1120, and 1130 are also within the scope of the present disclosure.

FIG. 8 is a circuit diagram showing in detail an example of the frequency sensing block of FIGS. 4 and 7, according to an embodiment of the present disclosure. In FIG. 8, a description the same as a description given with reference to FIG. 7 may be omitted. Referring to FIG. 8, the frequency sensing block 1100 may include the frequency accumulation circuit 1110, the on trigger generation circuit 1120, and the frequency sampling circuit 1130. The frequency accumulation circuit 1110 may include a first current source 1111, a NOT gate 1113, an accumulation switch circuit 1115, a reset switch circuit 1117, and a capacitor 1119. The frequency sampling circuit 1130 may include a sampling circuit 1131 and a low pass filter circuit 1133.

Referring to FIGS. 4, 7, and 8, the first current source 1111 may provide the current used by the frequency accumulation circuit 1110 to accumulate the frequency voltage FV. In an embodiment, the first current source 1111 may output current I1 of a first level. In an embodiment, the first current source 1111 may be connected to the accumulation switch circuit 1115 and may be supplied with a power supply voltage VDD. The first current source 1111 may provide the current I1 of the first level to the accumulation switch circuit 1115.

The NOT gate 1113 may be an inverter and may be connected between the AOT logic block 114 of FIG. 2 and the accumulation switch circuit 1115. In an embodiment, the NOT gate 1113 may invert the level of the first driver control signal DCS1. For example, when the level of the first driver control signal DCS1 is the high level HIGH, the NOT gate 1113 may deliver a signal of the low level LOW to the accumulation switch circuit 1115.

The accumulation switch circuit 1115 may be a switch that connects or disconnects the first current source 1111 to or from a first node N1. In an embodiment, the accumulation switch circuit 1115 may connect or disconnect the first current source 1111 to or from the first node N1 in response to an inverted signal of the first driver control signal DCS1. For example, the accumulation switch circuit 1115 may connect the first current source 1111 to the first node N1 in response to the inverted signal of the first driver control signal DCS1 being the high level HIGH.

The reset switch circuit 1117 may connect or disconnect the first node N1 to or from a ground node. The reset switch circuit 1117 may connect or disconnect the first node N1 to or from the ground node in response to the first driver control signal DCS1. For example, in response to the first driver control signal DCS1 being at the high level HIGH, the reset switch circuit 1117 may connect the first node N1 to the ground node and may reset the voltage level of the first node N1.

The capacitor 1119 may receive the current I1 of the first level and may accumulate a charge or a voltage level. In an embodiment, the capacitor 1119 may be connected between the first node N1 and the ground node. The voltage level of the charge accumulated by the capacitor 1119 may be the voltage level of the first node N1.

In an embodiment, the voltage of the first node N1 may be the frequency voltage FV. The first node N1 may be connected to the on trigger generation circuit 1120 and the frequency sampling circuit 1130. The frequency accumulation circuit 1110 may provide the frequency voltage FV to the on trigger generation circuit 1120 and the frequency sampling circuit 1130 through the first node N1.

The sampling circuit 1131 may sample the frequency voltage FV. In an embodiment, the sampling circuit 1131 may sample the frequency voltage FV in response to the sampling trigger STRIG. The sampling circuit 1131 may provide the sampling result of the frequency voltage FV to the low pass filter circuit 1133. In an embodiment, the sampling circuit 1131 may sample the frequency voltage FV before (or immediately before) the reset operation of the reset switch circuit 1117. For example, the sampling circuit 1131 may sample the maximum value of the frequency voltage FV in response to the sampling trigger STRIG received from the AOT logic block 114.

The low pass filter circuit 1133 may obtain a low pass component of the sampling result of the sampling circuit 1131. In an embodiment, the low pass filter circuit 1133 may obtain the low pass component of the sampling result of the sampling circuit 1131 and may generate the sampled frequency voltage SFV. The low pass filter circuit 1133 may provide the sampled frequency voltage SFV to the frequency comparing block 1200. In an embodiment, the low pass filter circuit 1133 may improve the stability of the operations of the switch regulator module 110 and the noise elimination module 1000.

The configurations, circuits, or operations of the frequency sensing block 1100 described through FIG. 8 are examples and the scope of the present disclosure is not limited thereto. It should be understood that an embodiment in which the frequency sensing block 1100 described through FIG. 8 does not include at least some of the circuits are also within the scope of the present disclosure. In an embodiment, the frequency sampling circuit 1130 may not include the low pass filter circuit 1133. In this case, the sampling circuit 1131 may generate the sampled frequency voltage SFV by sampling the frequency voltage FV, and may provide the sampled frequency voltage SFV to the frequency comparing block 1200.

FIG. 9 is a circuit diagram showing in detail an example of a frequency comparing block of FIG. 4, according to an embodiment of the present disclosure. Referring to FIG. 9, the frequency comparing block 1200 may include a comparison reference voltage source 1210 and an operational amplifying circuit 1220. The frequency comparing block 1200 according to an embodiment of the present disclosure is described in detail with reference to FIG. 9.

The comparison reference voltage source 1210 may provide a signal or voltage as one input of the operational amplifying circuit 1220. In an embodiment, the comparison reference voltage source 1210 may provide the signal or voltage that operates as a reference for the calculation of the sampled frequency voltage SFV. For example, the comparison reference voltage source 1210 may provide the operational amplifying circuit 1220 with voltage of a fixed level that operates as a reference for the calculation of the sampled frequency voltage SFV. The voltage provided by the comparison reference voltage source 1210 to the operational amplifying circuit 1220 will be described in more detail with reference to FIG. 12.

The operational amplifying circuit 1220 may perform the operational amplifying operation of the sampled frequency voltage SFV. In an embodiment, the operational amplifying circuit 1220 may receive the sampled frequency voltage SFV of FIG. 7 and may perform an operational amplifying operation. For example, the operational amplifying circuit 1220 may amplify a difference between the sampled frequency voltage SFV and the voltage generated by the comparison reference voltage source 1210.

In an embodiment, the operational amplifying circuit 1220 may output the frequency difference signal FDS. For example, the operational amplifying circuit 1220 may amplify the difference between the sampled frequency voltage SFV and the voltage of the comparison reference voltage source 1210 and may output the frequency difference signal FDS. For a more detailed example, the operational amplifying circuit 1220 may be an OP-AMP having the voltage generated by the comparison reference voltage source 1210 as an inverting input and having the sampled frequency voltage SFV as a non-inverting input.

The output terminal of the operational amplifying circuit 1220 may be connected to a second node N2. In an embodiment, a resistance element may be connected between the second node N2 and the ground node. The operational amplifying circuit 1220 may provide the driver control block 1300 with the frequency difference signal FDS generated through the second node N2. The detailed operation of the frequency comparing block 1200 of FIG. 9 will be described with reference to FIG. 12.

FIG. 10 is a block diagram showing in detail an example of the driver control block of FIG. 4, according to an embodiment of the present disclosure. A driver control block 1300 may correspond to the driver control block 1300 of FIG. 4. Referring to FIG. 10, the driver control block 1300 may include a driver control signal generation circuit 1310, a comparison signal generation circuit 1320, and an off trigger generation circuit 1330. The driver control block according to an embodiment of the present disclosure will be described in detail with reference to FIGS. 4 and 10.

The driver control signal generation circuit 1310 may generate the driver control signals DCS2 and DCS3. In an embodiment, the driver control signal generation circuit 1310 may generate the driver control signals DCS2 and DCS3 in response to the on-trigger signal ON_TRIG or an off-trigger signal OFF_TRIG. For example, the driver control signal generation circuit 1310 may generate the second driver control signal DCS2 in response to the on-trigger signal ON_TRIG. The second driver control signal DCS2 may correspond to changing the level of the second control signal CS2 of FIG. 2 to the high level HIGH. For example, a driver control signal having a value of DCS2 (e.g., logic high), may cause the second control signal CS2 of FIG. 2 to have the high level HIGH. The driver control signal generation circuit 1310 may generate the third driver control signal DCS3 in response to the off-trigger signal OFF_TRIG. The third driver control signal DCS3 may correspond to changing the level of the second control signal CS2 of FIG. 2 to the low level LOW. For example, a driver control signal having a value of DCS3 (e.g., logic low), may cause the second control signal CS2 of FIG. 2 to have the low level LOW.

The driver control signal generation circuit 1310 may transmit the driver control signals DCS2 and DCS3 to the driver block 112 of FIG. 2. The driver control signal generation circuit 1310 may generate a comparison start signal CSS and may deliver the comparison start signal CSS to the comparison signal generation circuit 1320. In an embodiment, the driver control signal generation circuit 1310 may generate the comparison start signal CSS in response to the on-trigger signal ON_TRIG. For example, the driver control signal generation circuit 1310 may generate the comparison start signal CSS in response to the level of the on-trigger ON_TRIG signal being changed from the low level LOW to the high level HIGH.

In an embodiment, the comparison start signal CSS may correspond to the on-trigger signal ON_TRIG. For example, the level of the on-trigger signal ON_TRIG may be opposite to the level of the comparison start signal CSS. For a more detailed example, when the level of the on-trigger signal ON_TRIG is the high level HIGH, the level of the comparison start signal CSS may be the low level LOW. For another example, the level of the comparison start signal CSS may be the same as the level of the on-trigger signal ON_TRIG.

The comparison signal generation circuit 1320 may generate a comparison signal COMP. In an embodiment, in response to the comparison start signal CSS, the comparison signal generation circuit 1320 may generate the comparison signal COMP or may initialize the comparison signal COMP. For example, the comparison signal generation circuit 1320 may start an operation of generating or accumulating the comparison signal COMP in response to the comparison start signal CSS. For another example, the comparison signal generation circuit 1320 may initialize the (e.g., accumulated) comparison signal COMP in response to the comparison start signal CSS.

In an embodiment, in response to a particular level of the comparison start signal CSS, the comparison signal generation circuit 1320 may increase or accumulate the level of the comparison signal COMP, or may initialize the level of the comparison signal COMP. For example, the comparison signal generation circuit 1320 may increase or accumulate the level of the comparison signal COMP in response to the level of the comparison start signal CSS being the low level LOW. (In this case, the comparison signal generation circuit 1320 may initialize the level of the comparison signal COMP in response to the level of the comparison start signal CSS being the high level HIGH.) For another example, the comparison signal generation circuit 1320 may increase or accumulate the level of the comparison signal COMP in response to the level of the comparison start signal CSS being the high level HIGH. (In this case, the comparison signal generation circuit 1320 may initialize the level of the comparison signal COMP in response to the level of the comparison start signal CSS being the low level LOW.)

The comparison signal generation circuit 1320 may transmit the generated comparison signal COMP to the off trigger generation circuit 1330. The comparison signal generation circuit 1320 will be described in more detail with reference to FIG. 10. The comparison signal COMP will be described in more detail with reference to FIG. 12.

The off trigger generation circuit 1330 may generate the off-trigger signal OFF_TRIG and may transmit the generated off-trigger signal OFF_TRIG to the driver control signal generation circuit 1310. In an embodiment, the off trigger generation circuit 1330 may generate the off-trigger signal OFF_TRIG based on the comparison signal COMP and the frequency difference signal FDS. In an embodiment, the frequency difference signal FDS may be a signal that is generated by the frequency comparing block 1200 and transmitted to the off trigger generation circuit 1330.

In an embodiment, the off trigger generation circuit 1330 may generate the off-trigger signal OFF_TRIG by comparing the comparison signal COMP and the frequency difference signal FDS. For example, when the level of the comparison signal COMP is greater than the level of the frequency difference signal FDS, the off trigger generation circuit 1330 may generate the off-trigger signal OFF_TRIG to have a particular value, for example, by transitioning the level of the off-trigger signal OFF_TRIG. For a more detailed example, in one embodiment, when the level of the comparison signal COMP is higher than the level of the frequency difference signal FDS, the off trigger generation circuit 1330 may change the level of the off-trigger signal OFF_TRIG to the high level HIGH.

The off trigger generation circuit 1330 will be described in more detail with reference to FIG. 11. The off-trigger signal OFF_TRIG will be described in more detail with reference to FIG. 12. The driver control block 1300 described with reference to FIG. 10 is an example, and the scope of the present disclosure is not limited thereto. The circuits 1310, 1320, and 1330 described in FIG. 10 may be divisions for convenience of description or functional divisions. The present disclosure should not be construed as being limited to an embodiment in which the driver control block 1300 is implemented through the circuits 1310, 1320, and 1330. It should be understood that an embodiment in which the driver control block 1300 does not include some of the circuits 1310, 1320, and 1330, an embodiment in which each of the circuits 1310, 1320, and 1330 does not perform at least some of the functions or operations described with reference to FIG. 10, or an embodiment in which at least some or all of the functions or operations of each of the circuits 1310, 1320, and 1330 are performed by other of the circuits 1310, 1320, and 1330 are also within the scope of the present disclosure.

FIG. 11 is a circuit diagram showing in detail an example of the driver control block of FIGS. 4 and 10, according to an embodiment of the present disclosure. In FIG. 11, a description the same as a description given with reference to FIG. 10 may be omitted. Referring to FIG. 11, the driver control block 1300 may include the driver control signal generation circuit 1310, the comparison signal generation circuit 1320, and the off trigger generation circuit 1330. The comparison signal generation circuit 1320 may include a second current source 1321, a NOT gate 1323, an accumulation switch circuit 1325, a reset switch circuit 1327, and a capacitor 1329. The off trigger generation circuit 1330 may include a comparator 1335.

Referring to FIGS. 4, 10, and 11, the second current source 1321 may provide the current used by the comparison signal generation circuit 1320 to accumulate the comparison signal COMP. In an embodiment, the second current source 1321 may output current I2 of a second level. In an embodiment, the second current source 1321 may be connected to the accumulation switch circuit 1325 and may be supplied with the power supply voltage VDD.

The second current source 1321 may provide the current I2 of the second level to the accumulation switch circuit 1325. In an embodiment, current levels of the current I1 of the first level in FIG. 8 and the current I2 of the second level may be the same as or different from each other.

The NOT gate 1323 may be an inverter connected between the driver control signal generation circuit 1310 and the reset switch circuit 1327. In an embodiment, the NOT gate 1323 may invert the level of the comparison start signal CSS. For example, when the level of the comparison start signal CSS is the high level HIGH, the NOT gate 1323 may deliver the signal of the low level LOW to the reset switch circuit 1327.

The accumulation switch circuit 1325 may be a switch configured to connect or disconnect the second current source 1321 to or from a third node N3. In an embodiment, the accumulation switch circuit 1325 may connect or disconnect the second current source 1321 to or from the third node N3 in response to the comparison start signal CSS. For example, the accumulation switch circuit 1325 may connect the second current source 1321 to the third node N3 in response to the comparison start signal CSS being the high level HIGH.

The reset switch circuit 1327 may be a switch configured to connect or disconnect the third node N3 to or from a ground node. The reset switch circuit 1327 may connect or disconnect the third node N3 to or from the ground node in response to the inverted signal of the comparison start signal CSS. For example, in response to the inverted signal of the comparison start signal CSS being at the high level HIGH, the reset switch circuit 1327 may connect the third node N3 to the ground node and may reset the voltage level of the third node N3.

The capacitor 1329 may receive the current I2 of the second level and may accumulate a charge or a voltage level. In an embodiment, the capacitor 1329 may be connected between the third node N3 and the ground node. The voltage level of the charge accumulated by the capacitor 1329 may be the level or the voltage level of the third node N3.

In an embodiment, the level of the third node N3 may be the comparison signal COMP. The third node N3 may be connected to the off trigger generation circuit 1330. The comparison signal generation circuit 1320 may provide the comparison signal COMP to the off trigger generation circuit 1330 through the third node N3.

In an embodiment, the comparator 1335 may generate the off-trigger signal OFF_TRIG by comparing the comparison signal COMP and the frequency difference signal FDS. For example, when the level of the comparison signal COMP is higher than the level of the frequency difference signal FDS, the comparator 1335 may generate the off-trigger signal OFF_TRIG or may change the level of the off-trigger signal OFF_TRIG to the high level HIGH. For example, the comparator 1335 may have the frequency difference signal FDS received from the frequency comparing block 1200 as an inverting input, the comparison signal COMP as a non-inverting input, and may output the off-trigger signal OFF_TRIG. The comparator 1335 may transmit the off-trigger signal OFF_TRIG to the driver control signal generation circuit 1310.

The configurations, circuits, or operations of the driver control block 1300 described through FIG. 11 are examples and the scope of the present disclosure is not limited thereto. For example, an embodiment in which the output of the NOT gate 1323 is delivered to the reset switch circuit 1327 and the comparison start signal CSS is delivered to the accumulation switch circuit 1325 should also be understood to fall within the scope of the present disclosure. It should be understood that an embodiment in which the driver control block 1300 described through FIG. 11 does not include at least some of the circuits is also within the scope of the present disclosure.

FIG. 12 is a timing diagram showing an example of changes in signals of the noise elimination module of FIGS. 4 to 11 and the switch regulator of FIG. 2 over time, according to an embodiment of the present disclosure. Referring to FIG. 12, the frequency voltage FV and the on-trigger signal ON_TRIG of FIG. 7 in the noise elimination module 1000, and the comparison signal COMP and the off-trigger signal OFF_TRIG of FIG. 10 are shown over time. The first driver control signal DCS1, the control signals CS1 and CS2, and the inductor current I_{L} of the switch regulator module 110 are shown over time. Operations of the switch regulator module 110 and the noise elimination module 1000 according to an embodiment of the present disclosure will be described with reference to FIGS. 2 and 4 to 12.

A fifth load current I_{LOAD5} may be the load current I_{LOAD} of FIG. 1 or may correspond to the load current I_{LOAD} of FIG. 1. The fifth load current I_{LOAD5} may be generated based on the inductor current I_{L}. For example, the fifth load current I_{LOAD5} may be generated based on the inductor current I_{L} passing through the inductive element ‘L’ of FIG. 2.

At a 21st time point t21, the level of the first driver control signal DCS1 may be transitioned to the high level HIGH. The first driver control signal DCS1 may transition to the high level HIGH at the 21st time point t21, and then may return to the low level LOW (e.g., before a 22nd time point t22). In response to the level of the first driver control signal DCS1 transitioning to the high level HIGH, the level of the first control signal CS1 may be changed to the high level HIGH.

The noise elimination module 1000 may start accumulating the frequency voltage FV at a time after the 21st time point t21, for example after the first driver control signal DCS1 returns to the low level LOW. In an embodiment, the frequency accumulation circuit 1110 of the frequency sensing block 1100 of the noise elimination module 1000 may start accumulating the frequency voltage FV after receiving the first driver control signal DCS1. Until a 27th time point t27 when the level of the first driver control signal DCS1 changes to the high level HIGH, the accumulation of the frequency voltage FV may increase. In an embodiment, a rate at which the frequency voltage FV is increased or accumulated may be constant. For example, the rate at which the frequency voltage FV is accumulated may be a value obtained by dividing the current I1 of the first level by the capacitance of the capacitor 1119.

Until a 23rd time point t23, the driver block 112 may change the levels of the control signals CS1 and CS2 in response to the first driver control signal DCS1. The driver block 112 may change the level of the first control signal CS1 from the high level HIGH to the low level LOW, and then may change the level of the second control signal CS2 from the low level LOW to the high level HIGH. For example, at the 22nd time point t22, the driver block 112 may change the level of the first control signal CS1 to the low level LOW and may change the level of the second control signal CS2 to the high level HIGH. The inductor current I_{L} may increase in response to the first switch 111a being turned on between the 21st time point t21 and the 22nd time point t22, and may decrease in response to the second switch 111b being turned on between the 22nd time point t22 and the 23rd time point t23.

The time between the 21st time point t21 and the 22nd time point t22 may be identical or similar to the on time TON in FIG. 5. The time between the 22nd time point t22 and the 23rd time point t23 may be identical or similar to the first off time TOFF1 in FIG. 5. The time between the 23rd time point t23 and a 24th time point t24 may be identical or similar to the first discontinuous current mode time TDCM1 in FIG. 5. The level of the inductor current I_{L} may be 0 in an interval between the 23rd time point t23 and the 24th time point t24.

At the 24th time point t24, the frequency voltage FV may be equal to or greater than a trigger reference level TRIG_REF. In an embodiment, the trigger reference level TRIG_REF may correspond to the frequency reference voltage of FIG. 7. In an embodiment, the frequency sensing block 1100 may generate and control the on-trigger signal ON_TRIG in response to the frequency voltage FV being greater than (or equal to) the trigger reference level TRIG_REF. For example, at the 24th time point t24, the frequency sensing block 1100 may control the on-trigger signal ON_TRIG by changing the level of the on-trigger signal ON_TRIG to the high level HIGH. In an embodiment, the frequency sensing block 1100 may compare the level of the frequency voltage FV with the trigger reference level TRIG_REF through the on trigger generation circuit 1120 and may change the level of the on-trigger signal ON_TRIG. In an embodiment, the on-trigger signal ON_TRIG may maintain the high level HIGH from the 24th time point t24 to the 27th time point t27.

The frequency sensing block 1100 may transmit the on-trigger signal ON_TRIG to the driver control block 1300, and the driver control block 1300 may generate the second driver control signal DCS2 in response to the on-trigger signal ON_TRIG. In an embodiment, the driver control block 1300 may generate the second driver control signal DCS2 through the driver control signal generation circuit 1310. In an embodiment, the driver control signal generation circuit 1310 may further generate the comparison start signal CSS in response to the on-trigger signal ON_TRIG, and may transmit the generated comparison start signal CSS to the comparison signal generation circuit 1320.

At the 24th time point t24, the comparison signal generation circuit 1320 may start increasing or accumulating the level of the comparison signal COMP. In an embodiment, until the 27th time point t27, the comparison signal generation circuit 1320 may increase or accumulate the level of the comparison signal COMP. In an embodiment, a rate at which the level of the comparison signal COMP is increased or accumulated may be constant. For example, the rate at which the level of the comparison signal COMP is accumulated may be a value obtained by dividing the current I2 of the second level by the capacitance of the capacitor 1329.

At the 24th time point t24, the driver block 112 may change the level of the second control signal CS2 to the high level HIGH in response to the second driver control signal DCS2. The inductor current I_{L} may flow in the opposite direction to the inductor current I_{L} between the 21st time point t21 to the 23rd time point t23 in response to the second switch 111b being turned on. For example, at the 24th time point t24, the inductor current I_{L} may start flowing in the direction of a switch node NS.

The level of the comparison signal COMP may be equal to the level of the frequency difference signal FDS at a 25th time point t25, and may be greater than the level of the frequency difference signal FDS after the 25th time point t25. In an embodiment, the off trigger generation circuit 1330 may generate the off-trigger signal OFF_TRIG in response to the level of the comparison signal COMP being greater than or equal to the level of the frequency difference signal FDS. For example, the off trigger generation circuit 1330 may control the off-trigger signal OFF_TRIG at the 25th time point t25, for example, by transitioning the level of the off-trigger OFF_TRIG. The off trigger generation circuit 1330 may provide the generated off-trigger signal OFF_TRIG to the driver control signal generation circuit 1310.

The driver control signal generation circuit 1310 may generate the third driver control signal DCS3 in response to the off-trigger signal OFF_TRIG. The driver control signal generation circuit 1310 may transmit the third driver control signal DCS3 to the driver block 112, and the driver block 112 may change the level of the second control signal CS2 to the low level LOW. The level of the inductor current I_{L} may decrease in response to the second switch 111b being turned off at the 25th time point t25. In an embodiment, until the 27th time point t27, the off-trigger signal OFF_TRIG may maintain the level of the 25th time point t25. In an embodiment, from the 25th time point t25 to the 27th time point t27, the control signals CS1 and CS2 may be maintained at the low level LOW.

The level of the inductor current I_{L} may decrease until a 26th time point t26, and thus the level of the inductor current I_{L} may become ‘0’ at the 26th time point t26. From the 26th time point t26 to the 27th time point t27, the level of the inductor current I_{L} may be ‘0’. The time between the 24th time point t24 and the 25th time point t25 may be identical or similar to the second off time TOFF2 in FIG. 5. The time between the 26th time point t26 and the 27th time point t27 may be identical or similar to the second discontinuous current mode time TDCM2 in FIG. 5.

At the 27th time point t27, the level of the first driver control signal DCS1 may change to the high level HIGH in a method the same as or similar to that at the 21st time point t21. In an embodiment, the level of the frequency voltage FV may be initialized in response to a change in the level of the first driver control signal DCS1. For example, at the 27th time point t27, the reset switch circuit 1117 may reset the level of the frequency voltage FV by connecting the first node N1 and the ground node. In an embodiment, the level of the on-trigger signal ON_TRIG may be changed in response to the level of the frequency voltage FV being reset. For example, at the 27th time point t27, the level of the on-trigger signal ON_TRIG may be changed to the low level LOW. In an embodiment, at the 27th time point t27, the frequency voltage FV may be sampled by the frequency sampling circuit 1130 before (e.g., immediately before) being reset. The comparison signal COMP may be initialized in response to the level of the on-trigger signal ON_TRIG being changed. For example, as the level of the on-trigger signal ON_TRIG changes, the comparison start signal CSS may be generated, or the level of the comparison start signal CSS may be changed, and the level of the comparison signal COMP may be initialized. In an embodiment, as the level of the comparison signal COMP is initialized, the level of the off-trigger signal OFF_TRIG may be changed. For example, the off trigger generation circuit 1330 may change the level of the off-trigger signal OFF_TRIG to the low level LOW in response to the level of the comparison signal COMP being initialized and becoming lower than the level of the frequency difference signal FDS.

From the 27th time point t27 to a 28th time point t28, the switch regulator module 110 and the noise elimination module 1000 may perform operation(s) identical or similar to the operations between the 21st time point t21 and the 27th time point t27. Even after the 28th time point t28, the switch regulator module 110 and the noise elimination module 1000 may repeat operations identical or similar to operations between the 21st time point t21 and the 27th time point t27 or operations between the 27th time point t27 and the 28th time point t28.

In an embodiment, before the 21st time point t21, the switch regulator module 110 or the noise elimination module 1000 may perform a preceding operation for performing the operations of FIG. 12. For example, before the 21st time point t21, the switch regulator module 110 and the noise elimination module 1000 may precede all or part of operations for obtaining a time interval between the 24th time point t24 and the 25th time point t25. For a more detailed example, before the 21st time point t21, the switch regulator module 110 and the noise elimination module 1000 may perform at least some or all of the operations for obtaining the level of the frequency difference signal FDS. In an embodiment, before the 21st time point t21, the switch regulator module 110 or the noise elimination module 1000 may perform at least some of the operations described with reference to FIG. 12.

The changes in signals over time, which are illustrated and described in FIG. 12, are examples and the scope of the present disclosure is not limited thereto. The time points t21 to t28 shown in FIG. 12 are used to indicate the order of operations, and the intervals between the time points t21 to t28 do not necessarily correspond to the actual time required to perform the operations. The signals or changes in levels of the signals, which are illustrated and described through FIG. 12, are examples and the scope of the present disclosure is not limited thereto. It should be understood that the waveforms and the levels in the graph of FIG. 12 are examples and may be exaggerated to some extent for convenience of description.

In FIG. 12, it is described that the comparison signal generation circuit 1320 increases, accumulates, or initializes the level of the comparison signal COMP in response to the comparison start signal CSS, but the scope of the present disclosure is not limited thereto. In an embodiment, in response to the on-trigger signal ON_TRIG or the inverted signal of the on-trigger signal ON_TRIG, the comparison signal generation circuit 1320 may increase or accumulate the level of the comparison signal COMP or may initialize the level of the comparison signal COMP. In FIG. 12, it is described that the comparison signal COMP is initialized at the 27th time point t27, but the scope of the present disclosure is not limited thereto. In an embodiment, the level of the comparison signal COMP may continue to increase even after the 27th time point t27, and may be initialized between the 27th time point t27 and the 28th time point t28, in response to the level of the on-trigger signal ON_TRIG changing to the high level HIGH.

In FIG. 12, it is described that the level of the on-trigger signal ON_TRIG is maintained at the high level HIGH from the 24th time point t24 to the 27th time point t27, but the scope of the present disclosure is not limited thereto. In an embodiment, the level of the on-trigger signal ON_TRIG may be changed to the high level HIGH at the 24th time point t24 and then may return to the low level LOW at the 27th time point t27. The level change of the on-trigger signal ON_TRIG at the 24th time point t24 may correspond to the generation of the second driver control signal DCS2 and the level increase or accumulation of the comparison signal COMP. The level change of the on-trigger signal ON_TRIG at the 27th time point t27 may correspond to the level initialization of the comparison signal COMP. (In this case, the level change of the on-trigger signal ON_TRIG may alternately correspond to the increase and accumulation of the level of the comparison signal COMP and the initialization of the level of the comparison signal COMP.) In FIG. 12, it is described that the level of the off-trigger signal OFF_TRIG is maintained at the high level HIGH from the 25th time point t25 to the 27th time point t27, but the scope of the present disclosure is not limited thereto. In an embodiment, the level of the off-trigger signal OFF_TRIG may change to the high level HIGH at the 25th time point t25, and then return to the low level LOW. In FIG. 12, it is described that both the level of the frequency voltage FV and the level of the comparison signal COMP start being increased or accumulated from ‘0’, but the scope of the present disclosure is not limited thereto. In an embodiment, at least some of the level of the frequency voltage FV or the level of the comparison signal COMP may have an offset value.

In FIG. 12, it is described that some or all of the operations of the switch regulator module 110 or the noise elimination module 1000 or operations for generating signals are performed simultaneously at each of the time points t21 to t28, but this is an example and the scope of the present disclosure is not limited thereto. In an embodiment, at each of the corresponding time points t21 to t28, at least all or part of the operations of the switch regulator module 110 or the noise elimination module 1000 may be performed sequentially or in parallel. It should be understood that the operations (or at least part of the operations) of the switch regulator module 110 or the noise elimination module 1000 at each of the time points t21 to t28 may be performed before or after each of the time points t21 to t28.

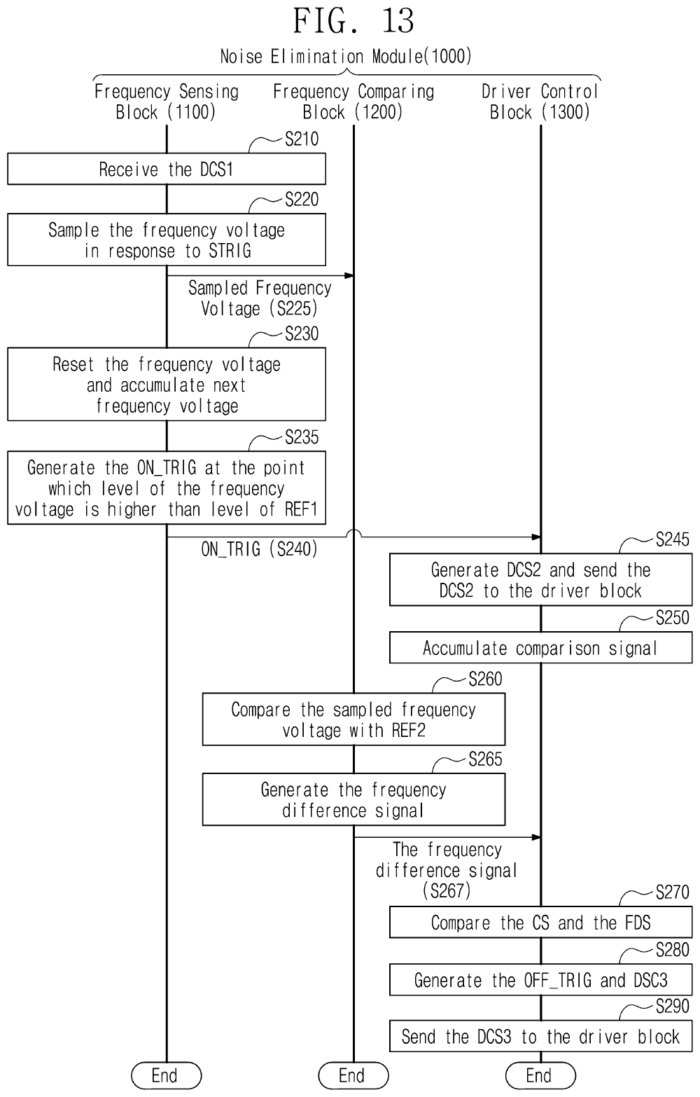

FIG. 13 is a flowchart showing an example of an operating method of the noise elimination module of FIGS. 4 to 12, according to an embodiment of the present disclosure. An operation method of the noise elimination module 1000 according to an embodiment of the present disclosure will be described with reference to FIGS. 4 to 13.

In operation S210, the frequency sensing block 1100 may receive the first driver control signal DCS1. For example, the frequency sensing block 1100 may receive the first driver control signal DCS1 by the frequency accumulation circuit 1110. In operation S220, the frequency sensing block 1100 may sample the frequency voltage FV (e.g., an existing frequency voltage FV at the beginning of the process) in response to the sampling trigger STRIG. Here, the sampling trigger STRIG may correspond to the first driver control signal DCS1. For example, the frequency sampling circuit 1130 may sample the frequency voltage FV in response to the sampling trigger STRIG and may generate the sampled frequency voltage SFV.

In operation S225, the frequency sensing block 1100 may transmit the sampled frequency voltage SFV to the frequency comparing block 1200. For example, the frequency sampling circuit 1130 may transmit the sampled frequency voltage SFV to a comparator of the frequency comparing block 1200.

In operation S230, the frequency sensing block 1100 may reset the frequency voltage FV and then may accumulate the frequency voltage FV. In an embodiment, the frequency sensing block 1100 may reset and accumulate the frequency voltage FV in response to the first driver control signal DCS1. For example, the frequency accumulation circuit 1110 may reset the frequency voltage FV in operation S230, and then may accumulate the frequency voltage FV. In FIG. 13, operation S225 and operation S230 are described as being performed sequentially, but at least some or all of operation S225 and operation S230 may be performed simultaneously.

In operation S235, the frequency sensing block 1100 may generate the on-trigger signal ON_TRIG at a point in time when the level of the frequency voltage FV exceeds a first reference. For example, at a point in time when the level of the frequency voltage FV exceeds the first reference, the on trigger generation circuit 1120 may control the on-trigger signal ON_TRIG to change the level of the on-trigger signal ON_TRIG. In operation S240, the frequency sensing block 1100 may transmit the generated on-trigger signal ON_TRIG to the driver control block 1300. For example, in operation S240, the on trigger generation circuit 1120 may transmit the on-trigger signal ON_TRIG to the driver control signal generation circuit 1310.

In operation S245, the driver control block 1300 may generate the second driver control signal DCS2 and may send the second driver control signal DCS2 to the driver block 112 of FIG. 2. The second driver control signal DCS2 may correspond to changing the level of the second control signal CS2 to the high level HIGH. In an embodiment, the driver control block 1300 may generate the second driver control signal DCS2 in response to the on-trigger signal ON_TRIG. For example, the driver control signal generation circuit 1310 may control a driver control signal to have a particular state or to change states, as reflected in second driver control signal DCS2, in response to the on-trigger signal ON_TRIG (received in operation S240).

In operation S250, the driver control block 1300 may increase or accumulate the level of the comparison signal COMP. In an embodiment, the driver control block 1300 may increase or accumulate the level of the comparison signal COMP in response to the on-trigger signal ON_TRIG. For example, the comparison signal generation circuit 1320 may start increasing or accumulating the level of the comparison signal COMP in response to the comparison start signal CSS generated by the driver control signal generation circuit 1310, which may be in response to the on-trigger signal ON_TRIG, for example, having or transitioning to the ON state.

In operation S260, the frequency comparing block 1200 may compare the sampled frequency voltage SFV with a second reference. In an embodiment, the frequency comparing block 1200 may generate a difference between the sampled frequency voltage SFV and a voltage generated by the comparison reference voltage source 1210, and may amplify that difference. For example, the operational amplifying circuit 1220 may generate the difference between the level of the sampled frequency voltage SFV and the voltage level of the comparison reference voltage source 1210 and may amplify that difference. In operation S265, the frequency comparing block 1200 may generate the frequency difference signal FDS based on the amplification result. For example, the operational amplifying circuit 1220 may generate the frequency difference signal FDS based on the arithmetic operation. In operation S267, the frequency comparing block 1200 may send the generated frequency difference signal FDS to the driver control block 1300.

In operation S270, the driver control block 1300 may compare the comparison signal COMP with the frequency difference signal FDS. In an embodiment, the off trigger generation circuit 1330 may compare the level of the comparison signal COMP with the level of the frequency difference signal FDS. In operation S280, the driver control block 1300 may generate the off-trigger signal OFF_TRIG and the third driver control signal DCS3. In an embodiment, when the level of the comparison signal COMP is greater than the level of the frequency difference signal FDS, the off trigger generation circuit 1330 may generate the off-trigger signal OFF_TRIG. In an embodiment, the driver control signal generation circuit 1310 may generate the third driver control signal DCS3 in response to the off-trigger signal OFF_TRIG, for example having or transitioning to an ON state.

In operation S290, the driver control block 1300 may send the third driver control signal DCS3 to the driver block 112 of FIG. 2. For example, the driver control signal generation circuit 1310 may send the third driver control signal DCS3 to the driver block 112 of FIG. 2. The third driver control signal DCS3 may correspond to changing the level of the second control signal CS2 to the low level LOW.

The sequence of operations illustrated in FIG. 13 is an example and the scope of the present disclosure is not limited thereto. It should be understood that an embodiment in which the sequence of the operations illustrated in FIG. 13 is changed, or an embodiment in which at least some of the operations in FIG. 13 are performed while being overlapped, is also within the scope of the present disclosure. For example, operation S260 and operation S265 may be performed simultaneously with operations S230 to S250.

FIG. 14 is a block diagram showing the power supply unit of FIG. 1, according to an embodiment of the present disclosure. A power supply unit 200 may correspond to the power supply unit 100 of FIG. 1. Referring to FIG. 14, the power supply unit 200 may include a switch regulator module 210 and a noise elimination module 220.

The switch regulator module 210 may correspond to the switch regulator module 110 of FIGS. 2, 5, 12 and 13, or may be identical or similar to the switch regulator module 110 of FIGS. 2, 5, 12 and 13. The noise elimination module 220 may correspond to the noise elimination module 1000 of FIGS. 3 to 13 or may be identical or similar to the noise elimination module 1000 of FIGS. 3 to 13.

In an embodiment, the noise elimination module 220 may generate a turn-on control signal TCS based on frequency information described through FIGS. 3 to 13 and may send the turn-on control signal TCS to the switch regulator module 210. In an embodiment, the turn-on control signal TCS may correspond to changing or adjusting the length of the turn-on retention time of the first switch 111a or the second switch 111b. The turn-on retention time may refer to the time required for the first switch 111a or the second switch 111b to remain in a turn-on state.

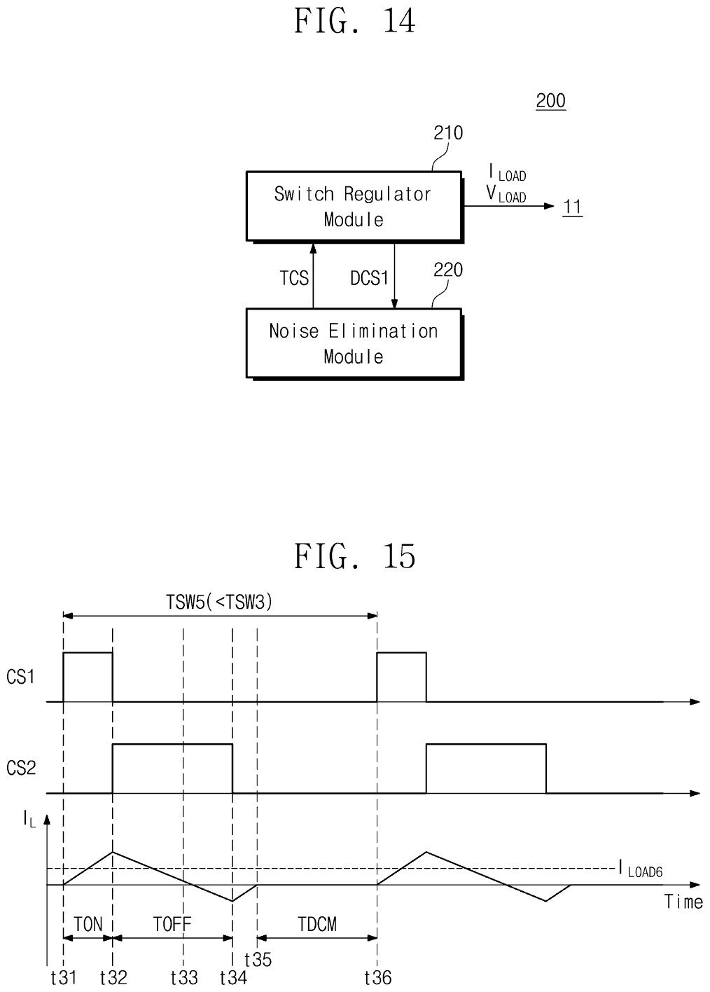

In an embodiment, the noise elimination module 220 may adjust the turn-on time of the switches 111a and 111b of FIG. 2 by generating the turn-on control signal TCS based on frequency information of the frequency sensing block 1100. For example, the noise elimination module 220 may correspond to the reduction in the level of the load current I_{LOAD} by decreasing the turn-on time of the first switch 111a or increasing the turn-on time of the second switch 111b, thereby making the frequency of the switch voltage V_{SW} higher than an audible frequency range at the same time. An example of the operation of the switch regulator module 210 replying to the turn-on control signal TCS of the noise elimination module 220 will be described in more detail with reference to FIG. 15.

In this case, the noise elimination module 220 may not include at least some or all of the blocks or circuits described with reference to FIGS. 3 to 14. Likewise, the noise elimination module 220 may include blocks or circuits that perform functions at least partially different from those of the blocks or circuits described with reference to FIGS. 3 to 14. For example, the noise elimination module 220 may include a frequency sensing block that obtains the frequency of the first driver control signal DCS1 and generates sampled frequency voltage corresponding to the frequency of the first driver control signal DCS1, and a driver control block that generates the turn-on control signal TCS corresponding to adjusting the length of the turn-on time of the first switch 111a or the second switch 111b based on the sampled frequency voltage value. In this case, the frequency sensing block may not generate the on-trigger signal ON_TRIG. However, this is an example and the present disclosure should not be construed as being limited thereto.

FIG. 15 is a timing diagram showing an example of changes in signals of the power supply unit of FIG. 14 over time, according to an embodiment of the present disclosure. Referring to FIG. 15, levels of signals and a level of the inductor current I_{L} of the switch regulator module 210 of FIG. 14 are illustrated. The operation of a power supply unit according to an embodiment of the present disclosure will be described with reference to FIGS. 1, 2, 14, and 15.

The sixth load current I_{LOAD6} may be the load current I_{LOAD} of FIG. 1 or may correspond to the load current I_{LOAD} of FIG. 1. The sixth load current I_{LOAD6} may be generated based on the inductor current I_{L}. For example, the sixth load current I_{LOAD6} may be generated based on the inductor current I_{L} passing through the inductive element ‘L’ of FIG. 2.

The operation of the switch regulator module 210 from a 31st time point t31 to a 32nd time point t32 may be identical to or similar to the operation of the switch regulator module 110 from the first time point t1 to the second time point t2 of FIG. 3 or the operation of the switch regulator module 110 from the eleventh time point t11 to the twelfth time point t12 of FIG. 5. As in FIG. 3 or FIG. 5, the switch regulator module 210 may change the first control signal CS1 to the high level HIGH to turn on the first switch 111a, and then may change the first switch 111a to the turn-off state at the 32nd time point t32. As in FIG. 3 or FIG. 5, the time between the 31st time point t31 and the 32nd time point t32 may be the on time TON. The inductor current I_{L} may increase in response to the first switch 111a being turned on from the 31st time point t31 to the 32nd time point t32.

The interval between the 32nd time point t32 and a 34th time point t34 may be the off time TOFF. The second switch 111b may be turned on from the 32nd time point t32 to the 34th time point t34. In an embodiment, the switch regulator module 210 may determine the length of the turn-on time between the 32nd time point t32 and the 34th time point t34 in response to the turn-on control signal TCS of FIG. 14. In an embodiment, the turn-on control signal TCS or the length of the adjusted turn-on time of the switches 111a and 111b included in the turn-on control signal TCS may be generated based on frequency information of the first driver control signal DCS1 obtained by the noise elimination module 220 of FIG. 14. The inductor current I_{L} may decrease in response to the second switch 111b being turned on, and the direction of the inductor current I_{L} may change at the 33rd time point t33. From the 34th time point t34, both the control signals CS1 and CS2 may have the low level LOW.

At the 34th time point t34, the second switch 111b may be turned off, and the magnitude of the inductor current I_{L} may decrease from the 34th time point t34 to the 35th time point t35 to reach ‘0’ at the 35th time point t35. The switch regulator module 210 may maintain the level of the inductor current I_{L} at ‘0’ during an interval between the 35th time point t35 and the 36th time point t36. From the 36th time point t36, the switch regulator module 210 may repeat the operation between the 31st time point t31 and the 36th time point t36.

In an embodiment, before the 31st time point t31, the power supply unit 200 may perform the preceding operation(s) required for the operation of FIG. 15. For example, before the 31st time point t31, the power supply unit 200 may perform at least some of the operations described through FIG. 15. For example, before the 31st time point t31, the power supply unit 200 may perform some or all of the operations for generating or changing the turn-on control signal TCS.

The level of the sixth load current I_{LOAD6} of FIG. 15 may be the same or substantially the same as the level of the third load current I_{LOAD3} of FIG. 3 or the level of the fourth load current I_{LOAD4} of FIG. 5, or may be less than the level of the third load current I_{LOAD3} or the fourth load current I_{LOAD4}. The interval between the 31st time point t31 and the 36th time point t36 of FIG. 15 may be a fifth switch period TSW5, and may be shorter than the third switch period TSW3 in FIG. 3. The fifth switch period TSW5 may be shorter than the reference period TREF.

According to this embodiment, the output voltage may rapidly decrease according to an operation of increasing the turn-on time of the second switch 111b, and thus the time required for the first driver control signal DCS1 to be regenerated may decrease. The power supply unit 200 operating according to FIG. 15 may eliminate noise caused by switch voltage V_{SW}. Accordingly, regardless of the magnitude of the load current I_{LOAD}, the power supply unit 200 may eliminate noise caused by an operation.

Changes in signals over time, which are illustrated and described in FIG. 15, and the operation(s) of the switch regulator module 210 and the noise elimination module 220 are examples and the scope of the present disclosure is not limited thereto. The time points t31 to t36 shown in FIG. 15 are used to indicate the order of operations, and the intervals between the time points t31 to t36 do not necessarily correspond to the actual time required to perform the operations. The signals or changes in levels of the signals, which are illustrated and described through FIG. 15, are examples and the scope of the present disclosure is not limited thereto. It should be understood that the waveforms and the levels in the graph of FIG. 15 are examples and may be exaggerated to some extent for convenience of description.

In FIG. 15, it is described that some or all of the operations of the power supply unit 200 are performed simultaneously at each of the time points t31 to t36, but this is an example and the scope of the present disclosure is not limited thereto. For example, it should be understood that operations (or at least part of the operations) of the power supply unit 200 for changing levels of the control signals CS1 and CS2 may also be performed before or after each of time points.

FIG. 16 is a block diagram showing the power supply unit of FIG. 1, according to an embodiment of the present disclosure. A power supply unit 300 may correspond to the power supply unit 100 of FIG. 1. Referring to FIG. 16, a power supply unit 300 may include a switch regulator module 310, a noise elimination module 320, and a dummy load module 330.

The switch regulator module 310 may correspond to the switch regulator module 110 of FIGS. 2, 5, 12 and 13, or may be identical or similar to the switch regulator module 110 of FIGS. 2, 5, 12 and 13. The noise elimination module 320 may correspond to the noise elimination module 1000 of FIGS. 3 to 13 or may be identical or similar to the noise elimination module 1000 of FIGS. 3 to 13.

In an embodiment, the noise elimination module 320 may generate a dummy load control signal DLC based on the frequency information described through FIGS. 4 to 13. In an embodiment, the dummy load module 330 may include a switch connected between an output node of the switch regulator module 310 and a dummy load. For example, the noise elimination module 320 may generate the dummy load control signal DLC, which includes a control signal for connecting the output node to the dummy load of the dummy load module 330, or a control signal for disconnecting the dummy load from the output node. In an embodiment, the second driver control signal DCS2 of FIGS. 3 to 14 may correspond to a control signal for connecting the dummy load to the output node. The third driver control signal DCS3 may correspond to a control signal for disconnecting the dummy load from the output node.

In a situation where the load current I_{LOAD} is small, the noise elimination module 320 of FIG. 16 may reduce the level of the output voltage of an output node more quickly through the dummy load module 330, thereby maintaining the frequency of the switch voltage V_{SW} outside the audible frequency range. In an embodiment, the noise elimination module 320 may not include at least some of the blocks or at least some of the circuits described through FIGS. 3 to 13.

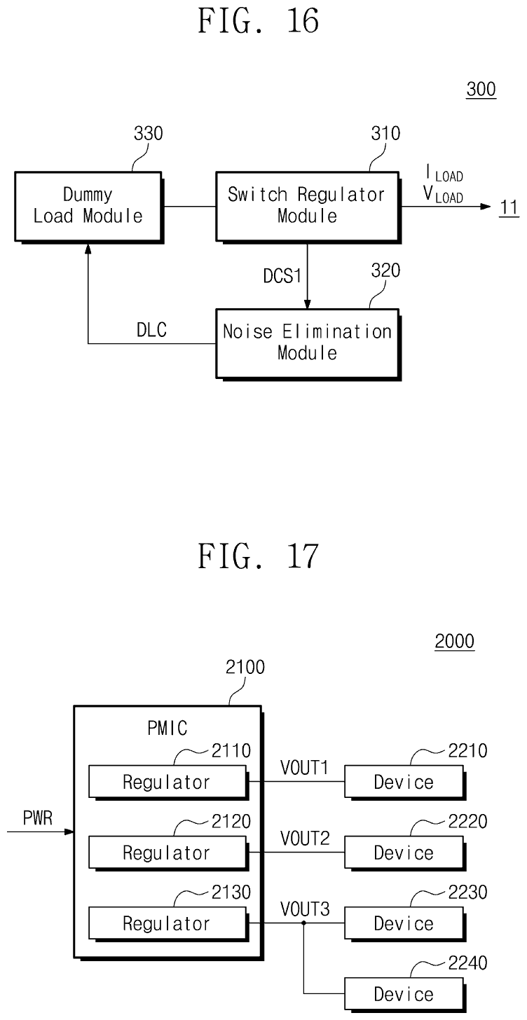

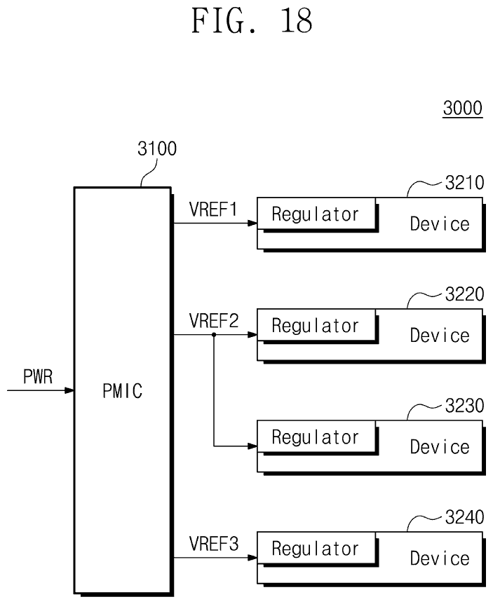

FIG. 17 is a block diagram illustrating an electronic system, to which a voltage regulator is applied, according to an embodiment of the present disclosure. Referring to FIG. 17, an electronic system 2000 may include a PMIC 2100 and a plurality of devices 2210 to 2240. In an embodiment, the electronic system 2000 may be one of various electronic devices such as a portable communication terminal, a personal digital assistant (PDA), a portable media player (PMP), a digital camera, a smartphone, a tablet computer, a laptop computer, and a wearable device. Alternatively, the electronic system 2000 may be implemented as a System-on-chip (SOC) or a System-on-Package (SoP).

The PMIC 2100 may receive an external power supply PWR and may generate a plurality of output voltages VOUT1, VOUT2, and VOUT3 based on the received external power supply PWR. For example, the PMIC 2100 may include a first voltage regulator 2110 configured to generate the first output voltage VOUT1, a second voltage regulator 2120 configured to generate the second output voltage VOUT2, and a third voltage regulator 2130 configured to generate the third output voltage VOUT3.

In an embodiment, the first to third voltage regulators 2110 to 2130 may be switch regulator modules described through FIGS. 2 to 16. For example, at least some of the first to third voltage regulators 2110 to 2130 may include the switch regulator module 310 and the dummy load module 330 of FIG. 16. In an embodiment, the first to third voltage regulators 2110 to 2130 may be connected to or may include the noise elimination module described with reference to FIGS. 3 to 16. The first to third voltage regulators 2110 to 2130 and the noise elimination modules connected to each of them may operate identically or similarly to the operations described through FIGS. 2 to 16.

The plurality of devices 2210 to 2240 may include electronic circuits, logic circuits, or memory circuits configured to support various operations of the electronic system 2000. For example, each of the plurality of devices 2210 to 2240 may serve as or may include the load unit 11 illustrated in FIG. 1. The plurality of devices 2210 to 2240 may receive power from the PMIC 2100 and may operate based on the power provided. For example, the first device 2210 may receive the first output voltage VOUT1 from the PMIC 2100 and may operate based on the received first output voltage VOUT1. The second device 2220 may receive the second output voltage VOUT2 from the PMIC 2100 and may operate based on the received second output voltage VOUT2. Each of the third device 2230 and the fourth device 2240 may receive the third output voltage VOUT3 from the PMIC 2100 and may operate based on the received third output voltage VOUT3.

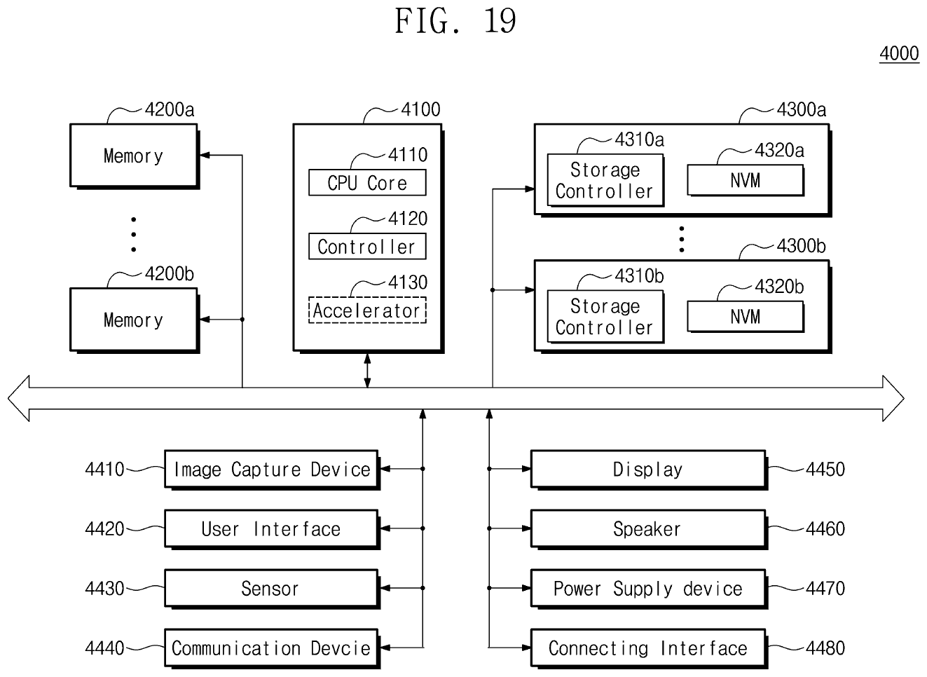

FIG. 18 is a block diagram illustrating an electronic system, to which a voltage regulator is applied, according to an embodiment of the present disclosure. Referring to FIG. 18, an electronic system 3000 may include a PMIC 3100 and a plurality of devices 3210 to 3240. For example, each of the plurality of devices 3210 to 3240 may serve as or may include the load unit 11 of FIG. 1.

The PMIC 3100 may generate a plurality of reference voltages VREF1 to VREF3 by using the external power supply PWR. For example, the PMIC 3100 may generate the plurality of reference voltages VREF1 to VREF3 by using a reference voltage generator.

The plurality of devices 3210 to 3240 may respectively receive the plurality of reference voltages VREF1 to VREF3 from the PMIC 3100 and may generate operating voltages by using the received reference voltages VREF1 to VREF3. For example, each of the plurality of devices 3210 to 3240 may include a voltage regulator. The voltage regulator of the first device 3210 may generate the first operating voltage used by the first device 3210 based on the first reference voltage VREF1. The voltage regulator of the second device 3220 may generate the second operating voltage used by the second device 3220 based on the second reference voltage VREF2. The voltage regulator of the third device 3230 may generate the third operating voltage used by the third device 3230 based on the second reference voltage VREF2. The voltage regulator of the fourth device 3240 may generate the fourth operating voltage used by the fourth device 3240 based on the third reference voltage VREF3.

In an embodiment, the voltage regulator included in each of the first to fourth devices 3210 to 3240 may be a switch regulator of FIGS. 2 to 16. In an embodiment, all or part of the voltage regulators included in each of the first to fourth devices 3210 to 3240 may be connected to the noise elimination modules described through FIGS. 3 to 16. The noise elimination module included in all or part of each of the first to fourth devices 3210 to 3240 may operate in a method the same as or similar to the method of the operations described through FIGS. 2 to 16.

FIG. 19 is a diagram of a system 4000 to which a storage device is applied, according to an embodiment. The system 4000 of FIG. 19 may basically be a mobile system, such as a portable communication terminal (e.g., a mobile phone), a smartphone, a tablet personal computer (PC), a wearable device, a healthcare device, or an Internet of things (IOT) device. However, the system 4000 of FIG. 19 is not necessarily limited to the mobile system and may be a PC, a laptop computer, a server, a media player, or an automotive device (e.g., a navigation device).

Referring to FIG. 19, the system 4000 may include a main processor 4100, memories (e.g., 4200a and 4200b), and storage devices (e.g., 4300a and 4300b). In addition, the system 4000 may include at least one of an image capturing device 4410, a user input device 4420, a sensor 4430, a communication device 4440, a display 4450, a speaker 4460, a power supplying device 4470, and a connecting interface 4480.

The main processor 4100 may control all operations of the system 4000, more specifically, operations of other components included in the system 4000. The main processor 4100 may be implemented as a general-purpose processor, a dedicated processor, or an application processor.

The main processor 4100 may include at least one CPU core 4110 and further include a controller 4420 configured to control the memories 4200a and 4200b and/or the storage devices 4300a and 4300b. In some embodiments, the main processor 4100 may further include an accelerator 4430, which is a dedicated circuit for a high-speed data operation, such as an artificial intelligence (AI) data operation. The accelerator 4430 may include a graphics processing unit (GPU), a neural processing unit (NPU) and/or a data processing unit (DPU) and be implemented as a chip that is physically separate from the other components of the main processor 4100.

The memories 4200a and 4200b may be used as main memory devices of the system 4000. Although each of the memories 4200a and 4200b may include a volatile memory, such as static random access memory (SRAM) and/or dynamic RAM (DRAM), each of the memories 4200a and 4200b may include non-volatile memory, such as a flash memory, phase-change RAM (PRAM) and/or resistive RAM (RRAM). The memories 4200a and 4200b may be implemented in the same package as the main processor 4100.

The storage devices 4300a and 4300b may serve as non-volatile storage devices configured to store data regardless of whether power is supplied thereto, and have larger storage capacity than the memories 4200a and 4200b. The storage devices 4300a and 4300b may respectively include storage controllers (STRG CTRL) 4310a and 4310b and NVM (Non-Volatile Memory)s 4320a and 4320b configured to store data via the control of the storage controllers 4310a and 4310b. Although the NVMs 4320a and 4320b may include flash memories having a two-dimensional (2D) structure or a three-dimensional (3D) V-NAND structure, the NVMs 4320a and 4320b may include other types of NVMs, such as PRAM and/or RRAM.

The storage devices 4300a and 4300b may be physically separated from the main processor 4100 and included in the system 4000 or implemented in the same package as the main processor 4100. In addition, the storage devices 4300a and 4300b may have types of solid-state devices (SSDs) or memory cards and be removably combined with other components of the system 100 through an interface, such as the connecting interface 4480 that will be described below. The storage devices 4300a and 4300b may be devices to which a standard protocol, such as a universal flash storage (UFS), an embedded multi-media card (eMMC), or a non-volatile memory express (NVMe), is applied, without being limited thereto.

The image capturing device 4410 may capture still images or moving images. The image capturing device 4410 may include a camera, a camcorder, and/or a webcam.

The user input device 4420 may receive various types of data input by a user of the system 4000 and include a touch pad, a keypad, a keyboard, a mouse, and/or a microphone.

The sensor 4430 may detect various types of physical quantities, which may be obtained from the outside of the system 4000, and convert the detected physical quantities into electric signals. The sensor 4430 may include a temperature sensor, a pressure sensor, an illuminance sensor, a position sensor, an acceleration sensor, a biosensor, and/or a gyroscope sensor.

The communication device 4440 may transmit and receive signals between other devices outside the system 4000 according to various communication protocols. The communication device 4440 may include an antenna, a transceiver, and/or a modem.

The display 4450 and the speaker 4460 may serve as output devices configured to respectively output visual information and auditory information to the user of the system 4000.

The power supplying device 4470 may appropriately convert power supplied from a battery (not shown) embedded in the system 4000 and/or an external power source, and supply the converted power to each of components of the system 4000. In an embodiment, the power supplying device 4470 may be or include the power supplying unit 100, 200, 300 in FIGS. 1 to 16.

The connecting interface 4480 may provide connection between the system 4000 and an external device, which is connected to the system 4000 and capable of transmitting and receiving data to and from the system 4000. The connecting interface 4480 may be implemented by using various interface schemes, such as advanced technology attachment (ATA), serial ATA (SATA), external SATA (e-SATA), small computer small interface (SCSI), serial attached SCSI (SAS), peripheral component interconnection (PCI), PCI express (PCIe), NVMe, IEEE 1394, a universal serial bus (USB) interface, a secure digital (SD) card interface, a multi-media card (MMC) interface, an eMMC interface, a UFS interface, an embedded UFS (eUFS) interface, and a compact flash (CF) card interface.

The above description refers to detailed embodiments for carrying out the present disclosure. The present disclosure may include embodiments in which a design is changed simply or which are easily changed, as well as the embodiments described above. In addition, technologies that are easily changed and implemented by using the above embodiments may be included in the present disclosure. While the present disclosure has been described with reference to embodiments described above, it will be apparent to those of ordinary skill in the art that various changes and modifications may be made thereto without departing from the spirit and scope of the present disclosure as set forth in the following claims.

According to an embodiment of the present disclosure, a power supply device including a noise elimination module capable of eliminating noise of audible frequency in a specific operating mode of a switch regulator is provided.

1. A power management integrated circuit (PMIC) comprising:
a switch regulator configured to generate load current, and including a first switch connected between input voltage and a switch node, and a second switch connected between ground voltage and the switch node; and
a noise elimination module,
wherein the noise elimination module includes:
a frequency sensing block configured to receive a first driver control signal corresponding to turning on and off the first switch and corresponding to turning on and off the second switch, and configured to sense a frequency of the first driver control signal;
a frequency comparing block configured to generate a frequency difference signal by comparing the frequency with a first reference frequency; and
a driver control block configured to generate a second driver control signal corresponding to turning on the second switch based on the frequency, and to generate a third driver control signal corresponding to turning off the second switch based on the frequency difference signal.

2. The PMIC of claim 1, wherein the driver control block is configured to generate the second driver control signal in response to the frequency being less than a second reference frequency.

3. The PMIC of claim 1, configured such that:
during a first time, the first switch is in an on state, and the second switch is in an off state,
during a second time, the first switch is in an off state, and the second switch is in an on state,
during a third time, the first switch and the second switch are in an off state, and
during a fourth time, the second switch is in an on state.

4. The PMIC of claim 1, wherein the frequency sensing block includes:
a frequency voltage accumulation circuit configured to receive the first driver control signal and to generate frequency voltage corresponding to the frequency;
an on trigger generation circuit configured to generate an on-trigger signal controlled by and transmitted to the driver control block based on the frequency voltage; and
a frequency sampling circuit configured to generate a sampled frequency voltage based on a sampling trigger corresponding to the frequency voltage and the first driver control signal.

5. The PMIC of claim 4, wherein the frequency comparing block is configured to:
receive the sampled frequency voltage; and
generate the frequency difference signal based on a difference between the sampled frequency voltage and a comparison reference voltage.

6. The PMIC of claim 5, wherein the frequency comparing block includes a comparator configured to receive the sampled frequency voltage as a non-inverting input, to receive the comparison reference voltage as an inverting input, and to output the frequency difference signal.

7. The PMIC of claim 4, wherein the driver control block includes:
a driver control signal generation circuit configured to generate the second driver control signal and a comparison start signal in response to the on-trigger signal;
a comparison signal generation circuit configured to start accumulating a comparison signal in response to the comparison start signal; and
an off trigger generation circuit configured to generate an off-trigger signal based on the comparison signal and the frequency difference signal.

8. The PMIC of claim 7, wherein the comparison signal generation circuit is configured to:
start accumulating the comparison signal in response to the on-trigger signal being at a high level HIGH; and
initialize the comparison signal in response to the on-trigger signal being at a low level LOW.

9. The PMIC of claim 7, wherein the driver control signal generation circuit generates the third driver control signal in response to the off-trigger signal.

10. The PMIC of claim 7, wherein the frequency voltage accumulation circuit includes:
a first current source connected to power supply voltage;
an accumulation switch circuit connected between the first current source and a first node, and configured to operate in response to an inverted signal of the first driver control signal;
a reset switch circuit connected to the first node and a ground node and configured to operate in response to the first driver control signal; and
a first capacitor connected between the first node and the ground node.

11. The PMIC of claim 10, wherein the frequency sampling circuit includes a sampling switch circuit that is connected to the first node and the frequency comparing block, and operates in response to the sampling trigger.

12. The PMIC of claim 7, wherein the comparison signal generation circuit includes:
a second current source connected to power supply voltage;
an accumulation switch circuit connected between the second current source and a second node, and configured to operate in response to an inverted signal of the comparison start signal;
a reset switch circuit connected between the second node and a ground node and configured to operate in response to the comparison start signal; and
a capacitor connected between the second node and the ground node,
wherein a level of the comparison signal corresponds to a level of the second node, and the comparison signal is provided to the off trigger generation circuit.

13. An operating method of a noise elimination module included in a power management integrated circuit (PMIC) and connected to a switch regulator, the method comprising:
sensing a frequency of a first driver control signal corresponding to turning on and off each of a first switch and a second switch of the switch regulator;
generating a second driver control signal corresponding to turning on the second switch when the frequency is less than a first reference frequency; and
generating a third driver control signal corresponding to turning off the second switch,
wherein the first switch is connected between input voltage and a switch node, and
wherein the second switch is connected between the switch node and a ground node.

14. The method of claim 13, wherein during a first time, the first switch is on, and the second switch is off,
wherein during a second time, the first switch is off, and the second switch is on,
wherein during a third time, the first switch and the second switch are off, and
wherein during a fourth time, the second switch is on and the first switch remains off.

15. The method of claim 13, wherein the noise elimination module includes:
a frequency sensing block configured to sense the frequency of the first driver control signal;
a frequency comparing block configured to generate a frequency difference signal by comparing the frequency with a second reference frequency; and
a driver control block configured to generate the second driver control signal in response to the frequency, and to generate the third driver control signal in response to the frequency difference signal.

16. The method of claim 15, wherein the sensing of the frequency includes:
receiving the first driver control signal;
generating a sampled frequency voltage by sampling a frequency voltage corresponding to the frequency in response to a sampling trigger corresponding to the first driver control signal; and
providing the sampled frequency voltage to the frequency comparing block.

17. The method of claim 16, wherein the frequency difference signal is generated by amplifying a difference between a level of the second reference frequency and the sampled frequency voltage.

18. The method of claim 15, wherein the frequency sensing block generates an on-trigger in response to the first driver control signal and provides the on-trigger to the driver control block, and
wherein the driver control block generates the second driver control signal in response to the on-trigger.

19. (canceled)

20. The method of claim 13, wherein the first reference frequency is an audible frequency.

21. An electronic device comprising:
a power supply unit configured to generate load current; and
a load unit configured to receive the load current and to operate based on the load current,
wherein the power supply unit includes:
a switch regulator module including a first switch connected between a power node having input voltage and a switch node, a second switch connected between the switch node and a ground node, and an inductor connected between the switch node and an output node, the load current flowing from the output node to the load unit; and
a noise elimination module configured to sense a frequency of voltage of the switch node and to control turning on and off the second switch based on the frequency.

22. (canceled)
